(19) United States
(12) Patent Application Publication
(10) Pub. No.: US 2021/0042401 A1
(43) Pub. Date: Feb. 11, 2021

(54) AUTHENTICATION DEVICE

(71) Applicant: MITSUMI ELECTRIC CO., LTD., Tama-shi, Tokyo (JP)

(72) Inventors: Fumiya NAGAI, Tama-shi, Tokyo (JP); Satoshi AJIKI, Tama-shi, Tokyo (JP)

(21) Appl. No.: 16/966,850

(22) PCT Filed: Dec. 18, 2018
(86) PCT No.: PCT/JP2018/046475

§ 371 Date: Jul. 31, 2020

(30) Foreign Application Priority Data
Feb. 1, 2018 (JP) 2018-016749

(51) Int. Cl. G06F 21/32; G06K 9/00; G06T 7/571; G06K 9/20; G06T 7/521

(52) U.S. Cl. CPC G06F 21/32; G06K 9/00288; G06K 9/00255; G06K 9/00201; G06T 7/571; G06T 2207/10048; G06K 9/00617; G06K 9/00604; G06T 7/521; G06T 2207/30201; G06T 2207/10028; G06K 9/209

(57) ABSTRACT

An authentication device comprising: a first imaging system for capturing a first optical image of an authentication subject; a second imaging system for capturing a second optical image of the authentication subject; a distance calculation unit for calculating a distance to each of a plurality of sites on the face of the authentication subjecton the basis of the first optical image and the second optical image; a three-dimensional information generation unit for generating three-dimensional information for the face of the authentication subject on the basis of the distance to each of the plurality of sites on the face of the authentication subject as calculated by the distance calculation unit; and an authentication unit configured so as to be capable of using the three-dimensional information for the face of the authentication subject as calculated by the three-dimensional information generation unit to execute a three-dimensional face authentication of the authentication subject.

### TECHNICAL FIELD

The present invention generally relates to authentication devices configured to be capable of performing three-dimensional face authentication using three-dimensional information of a face of an authentication target, in particular to an authentication device configured to be capable of creating three-dimensional information of a face of an authentication target based on an image magnification ratio between at least two optical images respectively formed by at least two optical systems whose changes of magnifications of the optical images according to a distance to each of a plurality of portions of the face of the authentication target are different from each other and performing three-dimensional face authentication using the three-dimensional information.

### BACKGROUND ART

Generally, a variety of devices containing a mobile phone, a smart phone, a notebook computer and a laptop computer have utilized an authentication technology using a combination of a password and an ID, an authentication technology using a physical key or an ID card and a biometric authentication technology such as face authentication, fingerprint authentication, vein authentication, voiceprint authentication, iris authentication and hand authentication in order to perform identity confirmation. In particular, the biometric authentication has an advantage that there is no burden on a user because the biometric authentication does not have problems such as forgetting of the password or the ID which is likely to be caused in the authentication using the combination of the password and the ID and theft and/or loss of the physical key or the ID card which is likely to be caused in the authentication using the physical key or the ID card.

Among various biometric authentication technologies, face authentication techniques which image a face of an authentication target and collate a captured face image with a face image of a person registered in advance have been widely used to perform the identity confirmation as camera modules have been mounted on various devices due to downsizing and high improvement of performances of the camera modules in recent years.

The above-described authentication using the face image has an “identity-fraud” problem that a third person impersonates a person to be authenticated with using any means to fraudulently pass the authentication. For example, the third person often makes an authentication device capture a face image of the person to be authenticated to perform the “identity-fraud” when the authentication is performed. In the identity-fraud utilizing the face image of the person to be authenticated, the face image printed on a media such as paper or displayed on a displaying device such as a monitor is used. Further, in the authentication method utilizing a face image of an authentication target, there is a possibility that an accuracy of the authentication decreases due to the presence or absence of cosmetic, a change in facial expression, a direction of face, a difference of illumination or the like at the time of imaging the face.

For solving these problems, a three-dimensional face authentication technology using three-dimensional information of the face of the authentication target (for example, a three-dimensional face shape and depth information of parts of the face such as eyes, a nose, a mouse and ears) has been used. For example, patent document 1 discloses an authentication device which obtains three-dimensional information of a face of an authentication target using a stereo method from a plurality of images obtained by imaging the authentication target with two cameras arranged at different positions so that a parallel disparity exists between the obtained images and performs three-dimensional face authentication for the authentication target based on the obtained three-dimensional information of the face of the authentication target.

Since the face image printed on the medium such as the paper or displayed on the display device such as the monitor is not stereoscopic, it is possible to prevent the identity-fraud using the face image by performing the three-dimensional authentication. Further, since the three-dimensional information of the face of the authentication target does not change or just little changes due to the presence or absence of cosmetics, the change in the facial expression, the direction of the face, the differences in the illumination or the like at the time of photographing, it is possible to more accurately perform the face authentication by performing the three-dimensional face authentication using the three-dimensional information of the face of the authentication target.

The stereo camera type authentication device as disclosed in the patent document 1 uses two or more cameras arranged at different positions to obtain a plurality of images having different parallel disparities and obtains the three-dimensional information of the face of the authentication target based on the parallel disparities between the plurality of obtained images. In order to accurately calculate the three-dimensional information of the face of the authentication target based on the parallel disparities between the plurality of images, it is necessary to obtain large parallel disparities among the images. Thus, it is necessary to arrange the two or more cameras with being spaced apart from each other at large intervals in one authentication device. This results in increase in a size of the authentication device. Further, in a case of using the stereo camera type authentication device, if the authentication target is located at a position very close to each camera, there is a case where an arbitrary feature point of the authentication target (subject) for obtaining the parallel disparity exists in one image but does not exist in another image due to a relationship between visual fields of the obtained images. In this case, there is a problem that the parallel disparity cannot be accurately obtained and thus it becomes difficult to accurately calculate a distance to the authentication target.

### RELATED ART DOCUMENTS

### Patent Document

[Patent document 1] JP 2007-122454A

### SUMMARY OF THE INVENTION

### Problems to be Solved by the Invention

The present invention has been made in view of the conventional problems mentioned above. Accordingly, it is an object of the present invention to provide an authentication device which can create the three-dimensional information of the face of the authentication target without using any parallel disparity between the plurality of images and perform the three-dimensional face authentication using the created three-dimensional information of the face of the authentication target.

### Means for Solving the Problems

The above object is achieved by the present inventions defined in the following (1) to (9).

(1) An authentication device, comprising
a first imaging system having a first optical system for collecting light from an authentication target to form a first optical image of the authentication target and a first image sensor for imaging the first optical image formed by the first optical system;
a second imaging system having a second optical system for collecting the light from the authentication target to form a second optical image of the authentication target and a second image sensor for imaging the second optical image formed by the second optical system;
a distance calculating part for calculating a distance to each of a plurality of portions of a face of the authentication target based on the first optical image and the second optical image;
a three-dimensional information creating part for creating three-dimensional information of the face of the authentication target based on the distance to each of the plurality of portions of the face of the authentication target calculated by the distance calculating part; and
an authenticating part configured to be capable of performing three-dimensional face authentication for the authentication target using the three-dimensional information of the face of the authentication target created by the three-dimensional information creating part,
   wherein the first optical system and the second optical system are configured so that a change of a magnification of the first optical image according to the distance to each of the plurality of portions of the face of the authentication target is different from a change of a magnification of the second optical image according to the distance to each of the plurality of portions of the face of the authentication target, and
wherein the distance calculating part calculates the distance to each of the plurality of portions of the face of the authentication target based on an image magnification ratio between the magnification of the first optical image and the magnification of the second optical image.

(2) The authentication device according to the above (1), wherein the first optical system and the second optical system are configured so that a distance from an exit pupil of the first optical system to an image formation position of the first optical image formed by the first optical system when the authentication target is located at an infinite distance point is different from a distance from an exit pupil of the second optical system to an image formation position of the second optical image formed by the second optical system when the authentication target is located at the infinite distance point, and thereby the change of the magnification of the first optical image according to the distance to each of the plurality of portions of the face of the authentication target is different from the change of the magnification of the second optical image according to the distance to each of the plurality of portions of the face of the authentication target.

(3) The authentication device according to the above (1) or (2), wherein a difference in a depth direction exists between a front principal point of the first optical system and a front principal point of the second optical system, and thereby the change of the magnification of the first optical image according to the distance to each of the plurality of portions of the face of the authentication target is different from the change of the magnification of the second optical image according to the distance to each of the plurality of portions of the face of the authentication target.

(4) The authentication device according to any one of the above (1) to (3), wherein the first optical system and the second optical system are configured so that a focal length of the first optical system and a focal length of the second optical system are different from each other, and thereby the change of the magnification of the first optical image according to the distance to each of the plurality of portions of the face of the authentication target is different from the change of the magnification of the second optical image according to the distance to each of the plurality of portions of the face of the authentication target.

(5) The authentication device according to any one of the above (1) to (4), wherein the authenticating part is configured to be capable of performing iris authentication and two-dimensional face authentication for the authentication target using a first image obtained by imaging the first optical image with the first image sensor and a second image obtained by imaging the second optical image with the second image sensor in addition to the three-dimensional face authentication.

(6) The authentication device according to the above (5), wherein the authenticating part is configured to perform at least one of the three-dimensional face authentication, the two-dimensional face authentication and the iris authentication according to a security level set in advance.

(7) The authentication device according to the above (5) or (6), wherein the first optical system and the second optical system are configured so that a focal length of the first optical system is longer than a focal length of the second optical system, and
wherein the authenticating part performs the iris authentication for the authentication target using the first image obtained by the first image sensor and performs the two-dimensional face authentication for the authentication target using the second image obtained by the second image sensor.

(8) The authentication device according to any one of the above (1) to (7), further comprising a projector for projecting a predetermined pattern onto the authentication target, and wherein the distance calculating part calculates the distance to each of the plurality of portions of the face of the authentication target based on the first optical image and the second optical image of the authentication target on which the predetermined pattern is projected by the projector.

(9) The authentication device according to any one of the above (1) to (8), further comprising an infrared light irradiation unit for irradiating infrared light onto the authentication target, and
wherein at least one of the first image sensor of the first imaging system and the second image sensor of the second imaging system is configured to be capable of imaging the infrared light.

### Effects of the Invention

The authentication device of the present invention uses the at least two optical systems whose changes of the magnifications of the optical images according to the distance to each of the plurality of portions of the face of the authentication target are different from each other to measure the distance to each of the plurality of portions of the face of the authentication target based on the image magnification ratio (the ratio between the magnifications) of the two optical images respectively formed by the two optical systems. Further, the authentication device of the present invention can create the three-dimensional information of the face of the authentication target based on the calculated distance to each of the plurality of portions of the face of the authentication target to perform the three-dimensional face authentication for the authentication target.

Therefore, the authentication device of the present invention does not need to secure a large parallel disparity unlike the conventional stereo camera type authentication device using the parallel disparity between the images. Thus, it is possible to accurately calculate the distance to each of the plurality of portions of the face of the authentication target even if the two optical systems are arranged with being close to each other. With this configuration, as compared with the conventional stereo camera type authentication device, it is possible to more downsize the authentication device. Further, since the authentication device of the present invention does not use the parallel disparity for calculating the distance to each of the plurality of portions of the face of the authentication target, it is possible to accurately calculate the distance to each of the plurality of portions of the face of the authentication target even if the authentication target is located at a position very close to the authentication device. In addition, according to the present invention, since it becomes unnecessary to design the authentication device with considering the parallel disparity, it is possible to increase a degree of freedom of design of the authentication device.

### BRIEF DESCRITION OF THE DRAWINGS

FIG. 1 is a view for explaining a distance measurement principle used in an authentication device of the present invention.

FIG. 2 is another view for explaining the distance measurement principle used in the authentication device of the present invention.

FIG. 3 is a graph for explaining that an image magnification ratio between a magnification of a first optical image formed by a first optical system shown in FIG. 2 and a magnification of a second optical image formed by a second optical system shown in FIG. 2 changes according to a distance to an authentication target.

FIG. 4 is a block diagram schematically showing an authentication device according to a first embodiment of the present invention.

FIG. 5 is a schematic diagram for showing an imaging area of a first imaging system and an imaging area of a second imaging system of the authentication device shown in FIG. 4. FIG. 5(a) is a schematic view of the subject, the first imaging system and the second imaging system viewed from the lateral side in order to illustrate the imaging areas of the first imaging system and the second imaging system of the authentication device shown in FIG. 4. FIG. 5(b) is a schematic view of the subject viewed from the front side in order to illustrate the imaging areas of the first imaging system and the second imaging system of the authentication device shown in FIG. 4.

FIG. 6 is a block diagram schematically showing a first imaging system and a second imaging system of an authentication device according to the second embodiment of the present invention.

FIG. 7 is a block diagram schematically showing a first imaging system and a second imaging system of an authentication device according to a third embodiment of the present invention.

FIG. 8 is a block diagram schematically showing a first imaging system, a second imaging system and an infrared light irradiation unit of an authentication device according to a fourth embodiment of the present invention.

FIG. 9 is a block diagram schematically showing a first imaging system, a second imaging system and a projector of an authentication device according to a fifth embodiment of the present invention.

FIG. 10 is a flowchart showing an authentication method performed by the authentication device of the present invention.

FIG. 11 is a flowchart showing an authentication process in the authentication method performed by the authentication device of the present invention in more detail.

FIG. 12 is a flowchart showing three-dimensional face authentication in the authentication method performed by the authentication device of the present invention.

### DETAILED DESCRIPTION OF THE PREFERRED EMBODIMENTS

First, a distance measurement principle for calculating a distance to a measurement target used in an authentication device of the present invention will be described.

A magnification “m_{OD}” of an optical image formed by an optical system can be calculated from a distance (subject distance) “a” from a front principal point (front principal plane) of the optical system to the measurement target, a distance “b_{OD}” from a rear principal point (rear principal plane) of the optical system to an image formation position of the optical image and a focal length “f” of the optical system according to the following equation (1) from the lens equation.

$$\begin{matrix}[ Equation 1 ] & \\ {m}_{OD} = \frac{{b}_{OD}}{a} = \frac{f}{a - f} & ( 1 )\end{matrix}$$

Further, a size “Y_{OD}” of the optical image can be calculated from the magnification “m_{OD}” of the optical image and an actual size “sz” of the measurement target according to the following equation (2).

$$\begin{matrix}[ Equation 2 ] & \\ {Y}_{OD} = sz \cdot {m}_{OD} = \frac{sz \cdot f}{a - f} & ( 2 )\end{matrix}$$

When an imaging surface of an image sensor (imaging element) is located at the image formation position of the optical image, that is, when the measurement target is in the best focus, the size “Y_{OD}” of the optical image can be calculated by the above equation (2). When the optical system has an autofocus function and always images the subject with the best focus, the size “Y_{OD}” of the optical image can be calculated by using the above equation (2).

However, when the optical system is a fixed focus system having no autofocus function and the imaging surface of the image sensor (imaging element) is not located at the image formation position of the subject image, that is, when defocus is present, it is required to consider a defocus amount, that is, a difference (shift amount) between the image formation position of the optical image and a position of the imaging surface of the image sensor in a depth direction (optical axis direction) in order to obtain the size “Y_{FD}” of the optical image formed on the imaging surface of the image sensor.

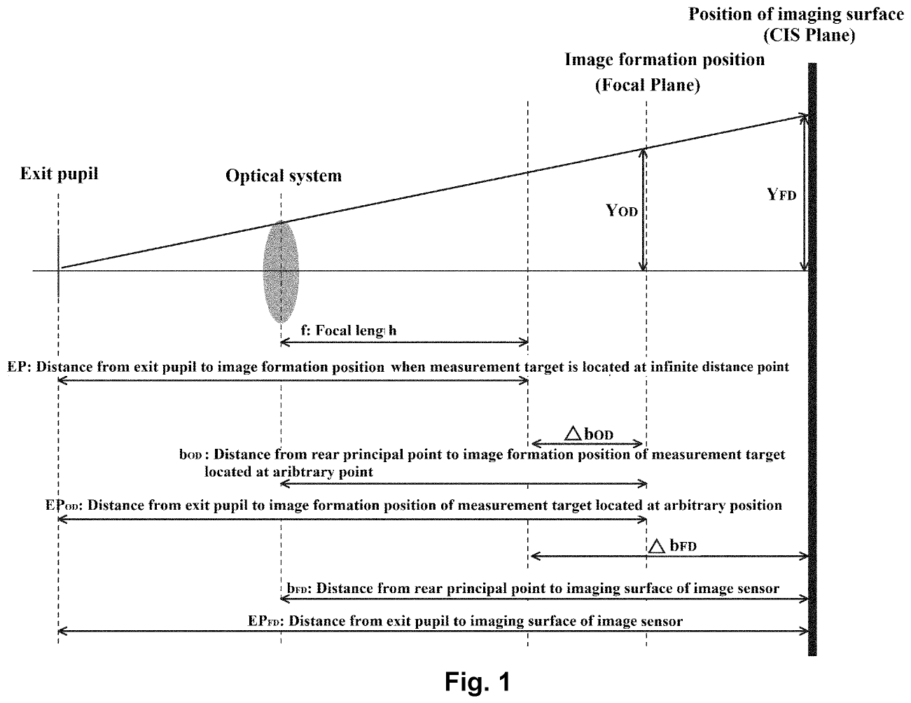

As shown in FIG. 1, a distance from an exit pupil of the optical system to an image formation position of the optical image when the measurement target is located at an infinite distance point is defined as “EP”, a distance from the exit pupil of the optical system to an image formation position of the optical image when the measurement target is located at an arbitrary distance “a” is defined as “EP_{OD}” and a distance from the exit pupil of the optical system to the imaging surface of the image sensor (Focus Distance) is defined as “EP_{FD}”. Further, a distance from the rear principal point of the optical system to the image formation position of the optical image when the measurement target is located at the arbitrary distance “a” is defined as “b_{OD}” and a distance from the rear principal point of the optical system to the imaging surface of the image sensor is defined as “b_{FD}”.

The distance “b_{OD}” from the rear principal point of the optical system to the image formation position of the optical image when the measurement target is located at the arbitrary distance “a” can be calculated according to the following equation (3) derived from the lens equation.

$$\begin{matrix}[ Equation 3 ] & \\ {b}_{OD} = \frac{1}{1 \text{/} f - 1 \text{/} a} = \frac{a \cdot f}{a - f} & ( 3 )\end{matrix}$$

Therefore, a difference “Δb_{OD}” between the focal length “f” and the distance “b_{OD}” can be calculated according to the following equation (4).

$$\begin{matrix}[ Equation 4 ] & \\ Δ {b}_{OD} = {b}_{OD} - f = \frac{a \cdot f}{a - f} - f = \frac{{f}^{2}}{a - f} & ( 4 )\end{matrix}$$

Further, the distance “b_{FD}” from the rear principal point of the optical system to the imaging surface of the image sensor can be calculated from a distance “a_{FD}” from the front principal point of the optical system to the measurement target when the optical image is in the best focus on the imaging surface of the image sensor according to the following equation (5) derived from the lens equation.

$$\begin{matrix}[ Equation 5 ] & \\ {b}_{FD} = \frac{1}{1 \text{/} f - 1 \text{/} {a}_{FD}} = \frac{{a}_{FD} \cdot f}{{a}_{FD} - f} & ( 5 )\end{matrix}$$

Therefore, a difference “Δb_{FD}” between the focal length “f” and the distance “b_{FD}” can be calculated according to the following equation (6).

$$\begin{matrix}[ Equation 6 ] & \\ Δ {b}_{FD} = {b}_{FD} - f = \frac{{a}_{FD} \cdot f}{{a}_{FD} - f} - f = \frac{{f}^{2}}{{a}_{FD} - f} & ( 6 )\end{matrix}$$

Further, as is clear from FIG. 1, a right-angled triangle having one vertex at the intersection of the optical axis and the exit pupil of the optical system and one side which is the size “Y_{OD}” of the optical image at the image formation position of the optical image when the measurement target is located at the arbitrary distance “a” is similar to a right-angled triangle having one vertex at the intersection of the optical axis and the exit pupil of the optical system and one side which is the size “Y_{FD}” of the optical image on the imaging surface of the image sensor. Therefore, “EP_{OD}”:“EP_{FD}”=“Y_{OD}”:“Y_{FD}” is satisfied from the similarity relationship and the size “Y_{FD}” of the optical image on the imaging surface of the image sensor can be calculated according to the following equation (7).

$$\begin{matrix}[ Equation 7 ] & \\ {EP}_{OD} \text{?} {EP}_{FD} = {Y}_{OD} \text{?} {Y}_{FD} \\ EP + Δ {b}_{OD } \text{?} EP + Δ {b}_{FD} = {Y}_{OD} \text{?} {Y}_{FD} \\ {Y}_{FD} = \frac{EP + Δ {b}_{FD}}{EP + Δ {b}_{OD }} \cdot {Y}_{OD} = ( \frac{\begin{matrix}{f}^{2} - EP \cdot f + \\ EP \cdot {a}_{FD }\end{matrix}}{{a}_{FD } - f} \text{/} \frac{\begin{matrix}{f}^{2} - EP \cdot f + \\ EP \cdot a\end{matrix}}{a - f} ) \cdot \frac{sz \cdot f}{a - f} = \frac{sz \cdot f \cdot ( \begin{matrix}{f}^{2} - EP \cdot f + \\ EP \cdot {a}_{FD }\end{matrix} )}{( {a}_{FD } - f ) \cdot ( \begin{matrix}{f}^{2} - EP \cdot f + \\ EP \cdot {a}_{ }\end{matrix} )} \\ \text{?} \text{indicates text missing or illegible when filed} & ( 7 )\end{matrix}$$

As is clear from the above equation (7), the size “Y_{FD}” of the optical image on the imaging surface of the image sensor can be expressed as a function of the actual size “sz” of the measurement target, the focal length “f” of the optical system, the distance “EP” from the exit pupil of the optical system to the image formation position of the optical image when the measurement target is located at the infinite distance point, the distance (subject distance) “a” from the optical system to the measurement target and the distance “a_{FD}” from the optical system to the measurement target when the optical image is in the best focus on the imaging surface of the image sensor.

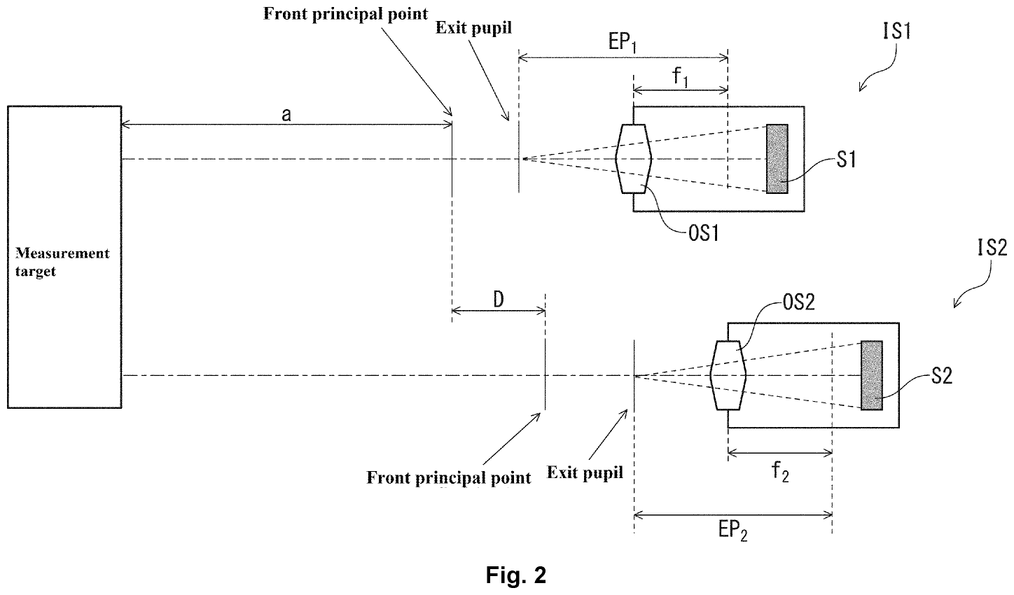

Next, as shown in FIG. 2, it is assumed that one measurement target is imaged by using two imaging systems IS1, IS2. The first imaging system IS1 includes a first optical system OS1 for collecting light from the measurement target to form a first optical image and a first image sensor S1 for imaging the first optical image formed by the first optical system OS1. The second imaging system IS2 includes a second optical system OS2 for collecting the light from the measurement target to form a second optical image and a second image sensor S2 for imaging the second optical image formed by the second optical system OS2. Further, as is clear from FIG. 2, although an optical axis of the first optical system OS1 of the first imaging system IS1 and an optical axis of the second optical system OS2 of the second imaging system IS2 are parallel to each other, the optical axis of the first optical system OS1 and the optical axis of the second optical system OS2 do not coincide with each other.

The first optical system OS1 and the second optical system OS2 are fixed-focus optical system each having different focal lengths “f₁” and “f₂”. When the first imaging system IS1 is configured, a position (lens position) of the first optical system OS1, that is, a separation distance between the first optical system OS1 and the first image sensor S1 is adjusted so that the first optical image of the measurement target which is located at an arbitrary distance “a_{FD1}” is formed on an imaging surface of the first image sensor S1, that is, the measurement target which is located at the arbitrary distance “a_{FD1}” is in the best focus. Similarly, when the second imaging system IS2 is configured, a position (lens position) of the second optical system OS2, that is, a separation distance between the second optical system OS2 and the second image sensor S2 is adjusted so that the second optical image of the measurement target which is located at an arbitrary distance “a_{FD2}” is formed on an imaging surface of the second image sensor S2, that is, the measurement target which is located at the arbitrary distance “a_{FD2}” is in the best focus.

Further, a distance from an exit pupil of the first optical system OS1 to an image formation position of the first optical image when the measurement target is located at an infinite distance point is “EP₁” and a distance from an exit pupil of the second optical system OS2 to an image formation position of the second optical image when the measurement target is located at the infinite distance point is “EP₂”.

The first optical system OS1 and the second optical system OS2 are configured and arranged so that a distance “D” in the depth direction (optical axis direction) exists between a front principal point (front principal plane) of the first optical system OS1 and a front principal point (front principal plane) of the second optical system OS2. Namely, when a distance (subject distance) from the front principal point of the first optical system OS1 to the measurement target is defined as “a”, a distance from the front principal point of the second optical system OS2 to the measurement target is “a+D”.

By using the similarity relationship described with reference to FIG. 1, a magnification “m₁” of the first optical image formed on the imaging surface of the first image sensor S1 by the first optical system OS1 can be calculated according to the following equation (8).

$$\begin{matrix}[ Equation 8 ] & \\ {m}_{1} = \frac{{EP}_{FD 1}}{{EP}_{OD 1}} \cdot {m}_{OD 1} = \frac{{EP}_{1} + Δ {b}_{FD 1}}{{EP}_{1} + Δ {b}_{OD 1}} \cdot {m}_{OD 1} & ( 8 )\end{matrix}$$

Here, “EP_{OD1}” is a distance from the exit pupil of the first optical system OS1 to an image formation position of the first optical image when the measurement target is located at the distance “a” and “EP_{FD1}” is a distance from the exit pupil of the first optical system OS1 to the imaging surface of the first image sensor S1. A positional relationship between the distance “EP_{OD1}” and the distance “EP_{FD1}” is determined at the time of configuring the first imaging system IS1 by adjusting the position (lens position) of the first optical system OS1 so that the measurement target located at the distance “a_{FD1}” is in the best focus. Further, “Δb_{OD1}” is a difference between the focal length “f₁” and a distance “b_{OD1}” from a rear principal point of the first optical system OS1 to the image formation position of the first optical image when the measurement target is located at the distance “a”. “Δb_{FD1}” is a difference between the focal length “f₁” and a distance “b_{FD1}” from the rear principal point of the first optical system OS1 to the imaging surface of the first image sensor S1. “m_{OD1}” is a magnification of the first optical image at the image formation position of the first optical image when the measurement target is located at the distance “a”.

Since the above equations (1), (4) and (6) can be applied to the image formation by the first optical system OS1, the above equation (8) can be expressed by the following equation (9).

$$\begin{matrix}[ Equation 9 ] & \\ {m}_{1} = ( \frac{{f}_{1}^{2} - {EP}_{1} \cdot {f}_{1} + {EP}_{1} \cdot {a}_{FD 1}}{{a}_{FD 1} - {f}_{1}} \text{/} \frac{{f}_{1}^{2} - {EP}_{1} \cdot {f}_{1} + {EP}_{1} \cdot a}{a - {f}_{1}} ) \cdot \frac{f}{a - {f}_{1}} = \frac{{f}_{1} \cdot ( {f}_{1}^{2} - {EP}_{1} \cdot {f}_{1} + {EP}_{1} \cdot {a}_{FD 1} )}{( {a}_{FD 1} - {f}_{1} ) \cdot ( {f}_{1}^{2} - {EP}_{1} \cdot {f}_{1} + {EP}_{1} \cdot a )} & ( 9 )\end{matrix}$$

Here, “a_{FD1}” is a distance from the front principal point of the first optical system OS1 to the measurement target when the first optical image is in the best focus on the imaging surface of the first image sensor S1.

Similarly, a magnification “m₂” of the second optical image formed on the imaging surface of the second image sensor S2 by the second optical system OS2 can be calculated according to the following equation (10).

$$\begin{matrix}[ Equation 10 ] & \\ {m}_{2} = \frac{{EP}_{FD 2}}{{EP}_{OD 2}} \cdot {m}_{OD 2} = \frac{{EP}_{2} + Δ {b}_{FD 2}}{{EP}_{2} + Δ {b}_{OD 2}} \cdot {m}_{OD 2} = ( \frac{{f}_{2}^{2} - {EP}_{2} \cdot {f}_{2} + {EP}_{2} \cdot {a}_{FD 2}}{{a}_{FD 2} - {f}_{2}} \text{/} \frac{{f}_{2}^{2} - {EP}_{2} \cdot {f}_{2} + {EP}_{2} \cdot ( a + D )}{( a + D ) - {f}_{2}} ) \cdot \frac{{f}_{2}}{( a + D ) - {f}_{2}} = \frac{{f}_{2} \cdot ( {f}_{2}^{2} - {EP}_{2} \cdot {f}_{2} + {EP}_{2} \cdot {a}_{FD 2} )}{( {a}_{FD 2} - {f}_{2} ) \cdot ( {f}_{2}^{2} - {EP}_{2} \cdot {f}_{2} + {EP}_{2} \cdot ( a + D ) )} & ( 10 )\end{matrix}$$

Here, “EP_{OD2}” is a distance from the exit pupil of the second optical system OS2 to an image formation position of the second optical image when the measurement target is located at the distance “a+D” and “EP_{FD2}” is a distance from the exit pupil of the second optical system OS2 to the imaging surface of the second image sensor S2. A positional relation between the distance “EP_{OD2}” and the distance “EP_{FD2}” is determined at the time of configuring the second imaging system IS2 by adjusting the position (lens position) of the second optical system OS2 so that the measurement target located at the arbitrary distance “a_{FD2}” is in the best focus. In addition, “Δb_{OD2}” is a difference between the focal length “f₂” and a distance “b_{OD2}” from the rear principal point of the second optical system OS2 to the image formation position of the second optical image when the measurement target is located at the distance “a+D”. “Δb_{FD2}” is a difference between the focal length “f₂” and a distance “b_{FD2}” from the rear principal point of the second optical system OS2 to the imaging surface of the second image sensor S2. “m_{OD2}” is a magnification of the second optical image at the image formation position of the second optical image when the measurement target is located at the distance “a+D”. “a_{FD2}” is a distance from the front principal point of the second optical system OS2 to the measurement target when the second optical image is in the best focus on the imaging surface of the second image sensor S2.

Therefore, an image magnification ratio “MR” between the magnification “m₁” of the first optical image formed on the imaging surface of the first image sensor S1 by the first optical system OS1 and the magnification “m₂” of the second optical image formed on the imaging surface of the second image sensor S2 by the second optical system OS2 can be calculated according to the following equation (11).

$$\begin{matrix}[ Equation 11 ] & \\ MR = \frac{{m}_{2}}{{m}_{1}} = \frac{{f}_{2}}{{f}_{1}} \cdot \frac{{a}_{FD 1} \cdot {f}_{1}}{{a}_{FD 2} - {f}_{2}} \cdot \frac{{f}_{2}^{2} - {EP}_{2} \cdot {f}_{2} + {EP}_{2} \cdot {a}_{FD 2}}{{f}_{1}^{2} - {EP}_{1} \cdot {f}_{1} + {EP}_{1} \cdot {a}_{FD 1}} \cdot \frac{{f}_{1}^{2} - {EP}_{1} \cdot {f}_{1} + {EP}_{1} \cdot a}{{f}_{2}^{2} - {EP}_{2} \cdot {f}_{2} + {EP}_{2} \cdot ( a + D )} = K \cdot \frac{{f}_{1}^{2} - {EP}_{1} \cdot {f}_{1} + {EP}_{1} \cdot a}{{f}_{2}^{2} - {EP}_{2} \cdot {f}_{2} + {EP}_{2} \cdot ( a + D )} & ( 11 )\end{matrix}$$

Here, “K” is a coefficient and represented by the following equation (12) constituted of the fixed values “f₁”, “f₂”, “EP₁”, “EP₂”, “a_{FD1}” and “a_{FD2}” determined by the configurations of the first imaging system IS1 and the second imaging system IS2.

$$\begin{matrix}[ Equation 12 ] & \\ K = \frac{{f}_{2}}{{f}_{1}} \cdot \frac{{a}_{FD 1} \cdot {f}_{1}}{{a}_{FD 2} - {f}_{2}} \cdot \frac{{f}_{2}^{2} - {EP}_{2} \cdot {f}_{2} + {EP}_{2} \cdot {a}_{FD 2}}{{f}_{1}^{2} - {EP}_{1} \cdot {f}_{1} + {EP}_{1} \cdot {a}_{FD 1}} & ( 12 )\end{matrix}$$

As is clear from the above equation (11), the image magnification ratio “MR” between the magnification “m₁” of the first optical image formed on the imaging surface of the first image sensor S1 by the first optical system OS1 and the magnification “m₂” of the second optical image formed on the imaging surface of the second image sensor S2 by the second optical system OS2 changes according to the distance “a” from the front principal point of the first optical system OS1 to the measurement target.

By solving the above equation (11) for the distance “a”, a general equation (13) for the distance “a” to the measurement target can be obtained.

$$\begin{matrix}[ Equation 13 ] & \\ a = \frac{K \cdot ( {f}_{1}^{2} - {EP}_{1} \cdot {f}_{1} ) - MR \cdot ( {f}_{2}^{2} - {EP}_{2} \cdot {f}_{2} + {EP}_{2} \cdot D )}{MR \cdot {EP}_{2} - K \cdot {EP}_{1}} & ( 13 )\end{matrix}$$

In the above equation (13), “f₁”, “f₂”, “EP₁”, “EP₂”, “D” and “K” are the fixed values determined by the configurations of the first imaging system IS1 and the second imaging system IS2. Thus, if the image magnification ratio “MR” can be obtained, it is possible to calculate the distance “a” from the front principal point of the first optical system OS1 to the measurement target.

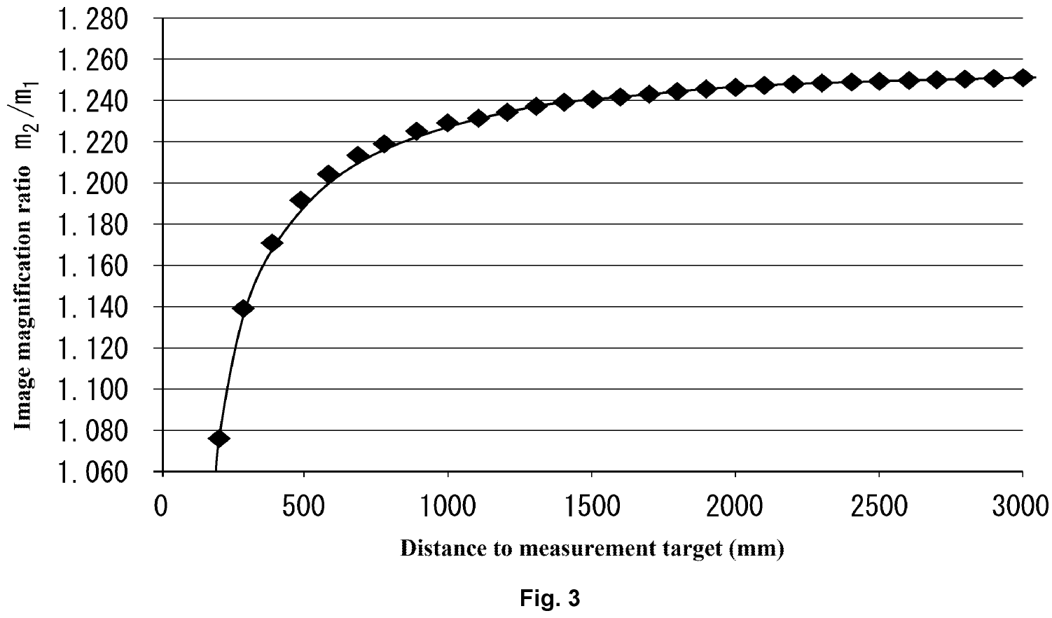

FIG. 3 shows an exemplary relationship between the image magnification ratio “MR” of the magnification “m₁” of the first optical image formed on the imaging surface of the first image sensor S1 by the first optical system OS1 and the magnification “m₂” of the second optical image formed on the imaging surface of the second image sensor S2 by the second optical system OS2 and the distance “a” to the measurement target, which is derived from the above equation (13). As is clear from FIG. 3, one-to-one relationship is established between the value of the image magnification ratio “MR” and the distance “a” to the measurement target. On the other hand, the image magnification ratio “MR” can be calculated according to the following equation (14).

$$\begin{matrix}[ Equation 14 ] & \\ MR = \frac{{m}_{2}}{{m}_{1}} = \frac{{Y}_{FD 2} \text{/} sz}{{Y}_{FD 1} \text{/} sz} = \frac{{Y}_{FD 2}}{{Y}_{FD 1}} & ( 14 )\end{matrix}$$

Here, “sz” is an actual size (height or width) of the measurement target, “Y_{FD1}” is a size (image height or image width) of the first optical image formed on the imaging surface of the first image sensor S1 by the first optical system OS1 and “Y_{FD2}” is a size (image height or image width) of the second optical image formed on the imaging surface of the second image sensor S2 by the second optical system OS2.

The size “Y_{FD1}” of the first optical image and the size “Y_{FD2}” of the second optical image can be calculated from an image (a first image) of the first optical image and an image (a second image) of the second optical image which are respectively obtained by imaging the first optical image with the first image sensor S1 and imaging the second optical image with the second image sensor S2. Therefore, by actually measuring the size “Y_{FD1}” of the first optical image and the size “Y_{FD2}” of the second optical image from the first image and the second image obtained by actually imaging the measurement target using the first imaging system IS1 and the second imaging system IS2, it is possible to obtain the image magnification ratio “MR” between the magnification “m₁” of the first optical image and the magnification “m₂” of the second optical image based on the measured size “Y_{FD1}” and the measured size “Y_{FD2}”.

In this regard, as is clear from the above equation (11), when the focal length “f₁” of the first optical system OS1 is equal to the focal length “f₂” of the second optical system OS2 (“f₁”=“f₂”), the distance “EP₁” from the exit pupil of the first optical system OS1 to the image formation position of the first optical image when the measurement target is located at the infinite distance point is equal to the distance “EP₂” from the exit pupil of the second optical system OS2 to the image formation position of the second optical image when the measurement target is located at the infinite distance point (“EP₁”=“EP₂”) and the difference “D” in the depth direction (the optical axis direction) between the front principal point of the first optical system OS1 and the front principal point of the second optical system OS2 does not exist (“D”=0), the image magnification ratio “MR” is not established as the function of the distance “a” and the image magnification ratio “MR” becomes a constant value. In this case, the change of the magnification “m₁” of the first optical image according to the distance “a” to the measurement target becomes the same as the change of the magnification “m₂” of the second optical image according to the distance “a” to the measurement target and thus it becomes impossible to calculate the distance “a” from the first optical system OS1 to the measurement target based on the image magnification ratio “MR”.

Further, as a special condition, even if the conditions of “f₁”≠“f₂”, “EP₁”≠“EP₂” and “D”=0 are satisfied, in a case of “f₁”=“EP₁” and “f₂”=“EP₂”, the image magnification ratio “MR” is not established as the function of the distance “a” and thus the image magnification ratio “MR” becomes a constant value. In such a special case, it is impossible to calculate the distance “a” from the first optical system OS1 to the measurement target based on the image magnification ratio “MR”.

Therefore, in the authentication device of the present invention, the first optical system OS1 and the second optical system OS2 are configured and arranged so that at least one of the following three conditions is satisfied, and thereby the change of the magnification “m₁” of the first optical image according to the distance “a” to the measurement target is different from the change of the magnification “m₂” of the second optical image according to the distance “a” to the measurement target.

(First condition) The focal length “f₁” of the first optical system OS1 and the focal length “f₂” of the second optical system OS2 are different from each other (“f₁”≠“f₂”)
(1) (Second condition) The distance “EP₁” from the exit pupil of the first optical system OS1 to the image formation position of the first optical image when the measurement target is located at the infinite distance point and the distance “EP₂” from the exit pupil of the second optical system OS2 to the image formation position of the second optical image when the measurement target is located at the infinite distance point are different from each other (“EP₁”≠“EP₂”).
(2) (Third condition) The difference “D” in the depth direction (the optical axis direction) exists between the front principal point of the first optical system OS1 and the front principal point of the second optical system OS2 (“D”≠0).

In addition, even if at least one of the first to third conditions described above is satisfied, in the above-described special case (“f₁”≠“f₂”, “EP₁”≠“EP₂”, “D”=0, “f₁”=“EP₂” and “f₂”=“EP₂”), the image magnification ratio “MR” is not established as the function of the distance “a” and thus it is impossible to calculate the distance “a” from the first optical system OS1 to the measurement target based on the image magnification ratio “MR”. Therefore, in order to calculate the distance “a” from the first optical system OS1 to the measurement target based on the image magnification ratio “MR”, the authentication device of the present invention is configured to further satisfy a fourth condition that the image magnification ratio “MR” is established as the function of the distance “a”.

Therefore, it is possible to calculate the distance “a” from the front principal point of the first optical system OS1 to the measurement target by calculating the image magnification ratio “MR” from the size “Y_{FD1}” of the first optical image and the size “Y_{FD2}” of the second optical image which are respectively actually measured from the first image and the second image obtained by using the authentication device of the present invention.

As described above, the authentication device calculates the image magnification ratio “MR” between the magnification “m₁” of the first optical image and the magnification “m₂” of the second optical image based on the actually measured size “Y_{FD1}” of the first optical image and the actually measured size “Y_{FD2}” of the second optical image to calculate the distance “a” from the front principal point of the first optical system OS1 to the measurement target.

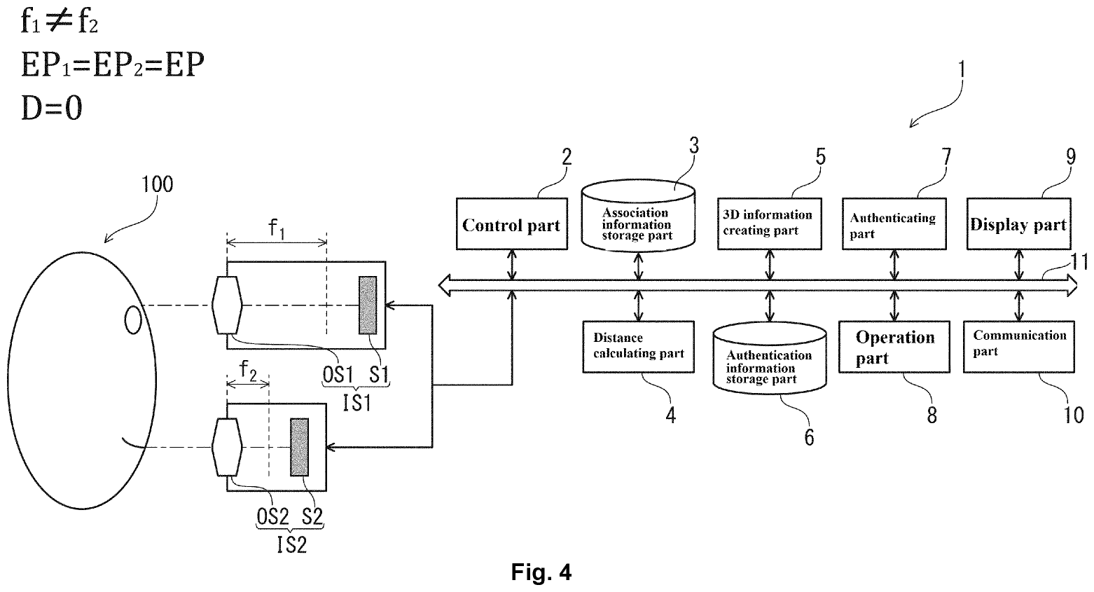

In the authentication device of the present invention, the measurement target is a plurality of portions on a face of an authentication target 100 which is a target of the authentication by the authentication device of the present invention as shown in FIG. 4. With this configuration, the authentication device of the present invention calculates a distance “a” to each of the plurality of portions of the face of the authentication target 100 (for example, parts of the face such as eyes, a nose, a mouth and ears) and creates three-dimensional (3D) information of the face of the authentication target 100 based on the distance “a”. The three-dimensional information of the face of the authentication target 100 created in this manner is used for three-dimensional face authentication.

Hereinafter, description will be given to the authentication device of the present invention which is configured to be capable of calculating the distance “a” to each of the plurality of portions of the face of the authentication target 100 with the above-described principle to create the three-dimensional information of the face of the authentication target 100 and performing the three-dimensional face authentication with the created three-dimensional information of the face based on preferred embodiments shown in the accompanying drawings.

### First Embodiment

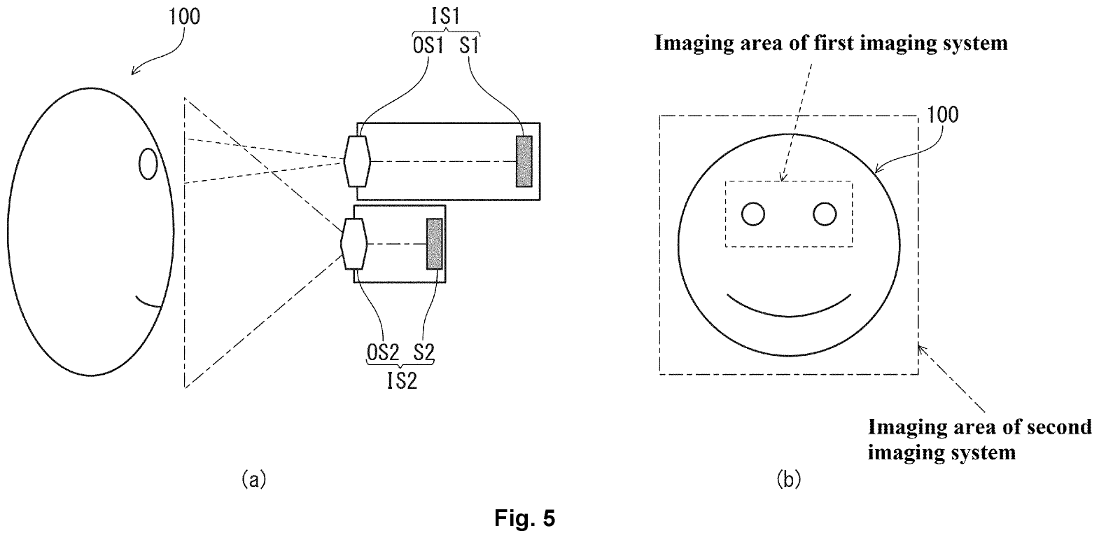

First, an authentication device according to a first embodiment of the present invention will be described with reference to FIGS. 4 and 5. FIG. 4 is a block diagram schematically showing the authentication device according to the first embodiment of the present invention. FIG. 5 is a schematic diagram for showing an imaging area of a first imaging system and an imaging area of a second imaging system of the authentication device shown in FIG. 4.

An authentication device 1 shown in FIG. 4 includes a control part 2 for performing control of the authentication device 1, a first imaging system IS1 having a first optical system OS1 for collecting light from an authentication target 100 to form a first optical image of the authentication target 100 and a first image sensor S1 for imaging the first optical image formed by the first optical system OS1, a second imaging system IS2 having a second optical system OS2 for collecting the light from the authentication target 100 to form a second optical image of the authentication target 100 and a second image sensor S2 for imaging the second optical image formed by the second optical system OS2, an association information storage part 3 storing association information for associating an image magnification ratio “MR” between a magnification “m₁” of the first optical image and a magnification “m₂” of the second optical image with a distance “a” to each of a plurality of portions of a face of the authentication target 100, a distance calculating part 4 for calculating the distance “a” to each of the plurality of portions of the face of the authentication target 100 based on the first optical image and the second optical image, a three-dimensional (3D) information creating part 5 for creating three-dimensional information of the face of the authentication target 100 based on the distance “a” to each of the plurality of portions of the face of the authentication target 100 calculated by the distance calculating part 4, an authentication information storage part 6 for storing authentication information required for performing authentication for the authentication target 100, an authenticating part 7 for performing an authentication process for the authentication target 100, an operation part 8 for inputting an operation from a user, a display part 9 such as a liquid crystal panel for displaying arbitrary information, a communication part 10 for performing communication with an external device and a data bus 11 for transmitting and receiving data between the components of the authentication device 1.

The authentication device 1 according to the present embodiment is characterized in that the first optical system OS1 and the second optical system OS2 are configured so as to satisfy the first condition that the focal length “f₁” of the first optical system OS1 and the focal length “f₂” of the second optical system OS2 are different from each other (“f₁”≠“f₂”) among the above-described three conditions required for calculating the distance “a” to the measurement target (that is, each of the plurality of portions of the face of the authentication target 100) based on the image magnification “MR”. On the other hand, in the present embodiment, the first optical system OS1 and the second optical system OS2 are configured and arranged so as not to satisfy the other two conditions (“EP₁”≠“EP₂” and “D”≠0) among the above-described three conditions. Further, the authentication device 1 of the present embodiment is configured to satisfy the fourth condition that the image magnification ratio “MR” is established as the function of the distance “a”.

Therefore, the above-mentioned general equation (13) for calculating the distance “a” to the measurement target (that is, each of the plurality of portions of the face of the authentication target 100) using the image magnification ratio “MR” is simplified by the conditions of “EP₁”=“EP₂”=“EP” and “D”=0 and thus can be expressed by the following equation (15).

$$\begin{matrix}[ Equation 15 ] & \\ a = \frac{K \cdot ( {f}_{1}^{2} - EP \cdot {f}_{1} ) - MR \cdot ( {f}_{2}^{2} - EP \cdot {f}_{2} )}{EP \cdot ( MR - K )} & ( 15 )\end{matrix}$$

Here, the coefficient “K” is expressed by the following equation (16).

$$\begin{matrix}[ Equation 16 ] & \\ K = \frac{{f}_{2}}{{f}_{1}} \cdot \frac{{a}_{FD 1} - {f}_{1}}{{a}_{FD 2} - {f}_{2}} \cdot \frac{{f}_{2}^{2} - EP \cdot {f}_{2} + EP \text{?} {a}_{FD 2}}{{f}_{1}^{2} - EP \cdot {f}_{1} + EP \text{?} {a}_{FD 1}} \\ \text{?} \text{indicates text missing or illegible when filed} & ( 16 )\end{matrix}$$

The authentication device 1 of the present embodiment calculates the image magnification ratio “MR” between the magnification “m₁” of the first optical image and the magnification “m₂” of the second optical image by imaging the authentication target 100 with the first imaging system IS1 and the second imaging system IS2 to calculate the distance “a” to each of the plurality of portions of the face of the authentication target 100 according to the above equation (15). The authentication device 1 of the present embodiment creates the three-dimensional information of the face of the authentication target 100 based on the calculated distance “a” to each of the plurality of portions of the face of the authentication target 100 to perform three-dimensional face authentication.

Hereinafter, each component of the authentication device 1 will be described in detail. The control part 2 transmits and receives various data and/or various instructions among the components of the authentication device 1 through the data bus 11 to perform the control of the authentication device 1. The control part 2 includes a processor for performing operational processes and a memory storing data, programs, modules and the like required for performing the control of the authentication device 1. The processor of the control part 2 uses the data, the programs, the modules and the like stored in the memory to perform the control of the authentication device 1. Further, the processor of the control part 2 can provide desired functions by using each component of the authentication device 1. For example, the processor of the control part 2 can use the distance calculating part 4 to perform a process for calculating the distance “a” to each of the plurality of portions of the face of the authentication target 100 based on the first optical image and the second optical image respectively imaged by the first imaging system IS1 and the second imaging system IS2.

For example, the processor of the control part 2 is one or more operation units such as microprocessors, microcomputers, microcontrollers, digital signal processors (DSPs), central processing units (CPUs), memory control units (MCUs), graphic processing units (GPUs), state machines, logic circuitries, application specific integrated circuits (ASICs) and combinations thereof that can perform operational processes for manipulating signals or the like based on computer-readable instructions. Among other capabilities, the processor of the control part 2 is configured to fetch computer-readable instructions (such as data, programs and modules) stored in the memory of the control part 2 to perform signal control and signal manipulation.

The memory of the control part 2 is one or more removable or non-removable computer-readable media containing volatile memories (such as RAMs, SRAMs and DRAMs), non-volatile memories (such as ROM, EPROMs, EEPROM, flash memories, hard disks, optical discs, CD-ROMs, digital versatile discs (DVDs), magnetic cassettes, magnetic tapes and magnetic disks) and combinations thereof.

Each of the first imaging system IS1 and the second imaging system IS2 is configured and arranged so as to image the authentication target 100. The first optical system OS1 of the first imaging system IS1 has a function of collecting the light from the authentication target 100 to form the first optical image on an imaging surface of the first image sensor S1 of the first imaging system IS1. The second optical system OS2 of the second imaging system IS2 has a function of collecting the light from the authentication target 100 to form the second optical image on an imaging surface of the second image sensor S2 of the second imaging system IS2. Each of the first optical system OS1 and the second optical system OS2 is constituted of one or more lenses and one or more optical elements such as an aperture. Further, as shown in the drawings, although an optical axis of the first optical system OS1 and an optical axis of the second optical system OS2 are parallel to each other, the optical axis of the first optical system OS1 and the optical axis of the second optical system OS2 do not coincide with each other.

As described above, the first optical system OS1 and the second optical system OS2 are configured so that the focal length “f₁” of the first optical system OS1 and the focal length “f₂” of the second optical system OS2 are different from each other (“f₁”≠“f₂”). With this configuration, a change of the magnification “m₁” of the first optical image formed by the first optical system OS1 according to the distance “a” to each of the plurality of portions of the face of the authentication target 100 is different from a change of the magnification “m₂” of the second optical image formed by the second optical system OS2 according to the distance “a” to each of the plurality of portions of the face of the authentication target 100.

In the present embodiment, the first optical system OS1 and the second optical system OS2 are configured so that the focal length “f₁” of the first optical system OS1 is longer than the focal length “f₂” of the second optical system OS2 (“f₁”>“f₂”).

In this regard, the configurations and the arrangements of the first optical system OS1 and the second optical system OS2 in the present embodiment may be any aspect as long as the above-mentioned first condition (“f₁”≠“f₂”) is satisfied, and thereby the change of the magnification “m₁” of the first optical image with respect to the distance “a” to each of the plurality of portions of the face of the authentication target 100 and the change of the magnification “m₂” of the second optical image with respect to the distance “a” to each of the plurality of portions of the face of the authentication target 100 are different from each other.

The first image sensor S1 of the first imaging system IS1 has a function of imaging the first optical image formed by the first optical system OS1 to obtain a first image (which is image data). Similarly, the second image sensor S2 of the second imaging system IS2 has a function of imaging the second optical image formed by the second optical system OS2 to obtain a second image (which is image data).

The first image sensor S1 and the second image sensor S2 may be a color image sensor such as a CMOS image sensor or a CCD image sensor having a color filter such as an RGB primary color filter and a CMY complementary color filter arranged in any pattern such as a bayer arrangement or a monochrome image sensor without such a color filter.

The first optical image is formed on the imaging surface of the first image sensor S1 by the first optical system OS1 and the colored or monochrome first image of the first optical image is obtained by the first image sensor S1. The obtained first image is transmitted to the control part 2, the distance calculating part 4 and the authenticating part 7 through the data bus 11. Similarly, the second optical image is formed on the imaging surface of the second image sensor S2 by the second optical system OS2 and the colored or monochrome second image of the second optical image is obtained by the second image sensor S2. The obtained second image is transmitted to the control part 2, the distance calculating part 4 and the authenticating part 7 through the data bus 11. The first image and the second image transmitted to the distance calculating part 4 are used for calculating the distance “a” to each of the plurality of portions of the face of the authentication target 100. On the other hand, the first image and the second image transmitted to the authenticating part 7 are used for performing two-dimensional (2D) face authentication and/or iris authentication for the authentication target 100. The first image and the second image transmitted to the control part 2 are used for the image displaying due to the display part 9 and the communication of the images due to the communication part 10.

In this regard, although the first imaging system IS1 and the second imaging system IS2 are respectively configured in different housings in the illustrated embodiment, the present invention is not limited to thereto. The scope of the present invention also involves another aspect in which the first imaging system IS1 and the second imaging system IS2 are configured in one housing.

The association information storage part 3 is an arbitrary non-volatility storage medium (such as a hard disk and a flash memory) for storing the association information for associating the image magnification ratio “MR” (“m₂”/“m₁”) between the magnification “m₁” of the first optical image and the magnification “m₂” of the second optical image with the distance (subject distance) “a” from the front principal point of the first optical system OS1 to each of the plurality of portions of the face of the authentication target 100. The association information stored in the association information storage part 3 is information for calculating the distance “a” to each of the plurality of portions of the face of the authentication target 100 from the image magnification ratio “MR” (“m₂”/“m₁”) between the magnification “m₁” of the first optical image and the magnification “m₂” of the second optical image.

Typically, the association information stored in the association information storage part 3 contains the above equation (15) (or the general equation (13)) for calculating the distance “a” to each of the plurality of portions of the face of the authentication target 100 based on the image magnification ratio “MR” and the above-described fixed values used in these equations and determined by the configurations and the arrangements of the first optical system OS1 and the second optical system OS2 (for example, the fixed values “f₁”, “f₂”, “EP” and “K” for the above equation (15)). Alternatively, the association information stored in the association information storage part 3 may be a look-up table for uniquely associating the image magnification ratio “MR” with the distance “a” to each of the plurality of portions of the face of the authentication target 100. By referring to such association information stored in the association information storage part 3, it becomes possible to calculate the distance “a” to each of the plurality of portions of the face of the authentication target 100 based on the image magnification ratio “MR”.

The distance calculating part 4 has a function of calculating the distance “a” to each of the plurality of portions of the face of the authentication target 100 based on the first optical image and the second optical image respectively imaged by the first imaging system IS1 and the second imaging system IS2. More specifically, the distance calculating part 4 has a function of calculating the distance “a” to each of the plurality of portions of the face of the authentication target 100 based on the image magnification ratio “MR” between the magnification “m₁” of the first optical image and the magnification “m₂” of the second optical image. The distance calculating part 4 receives the first image from the first image sensor S1 of the first imaging system IS1 and receives the second image from the second image sensor S2 of the second imaging system IS2.

After that, the distance calculating part 4 subjects a filtering process such as a Canny method on the first image and the second image to extract edge portions of the first optical image in the first image and edge portions of the second optical image in the second image. The distance calculating part 4 calculates a size (image width or image height) “Y_{FD1}” of each of the plurality of portions of the first optical image based on the extracted edge portions of the first optical image and calculates a size (image width or image height) “Y_{FD2}” of each of the plurality of portions of the second optical image based on the extracted edge portions of the second optical image.

The distance calculating part 4 obtains the size “Y_{FD1}” of each of the portions of the first optical image and the size “Y_{FD2}” of each of the portions of each of the first optical image and the second optical image by changing combinations of the edge portions used for calculating the size “Y_{FD1}” and the size “Y_{FD2}”.

For example, the distance calculating part 4 may select the edge portions adjacent to each other in the height direction among the extracted edge portions and measure a separation distance between the selected edge portions to obtain the image height of an arbitrary portion in the optical image. Similarly, the distance calculating part 4 may select the edge portions adjacent to each other in the width direction among the extracted edge portions and measure a separation distance between the selected edge portions to obtain the image width of an arbitrary portion in the optical image.

The selection for the extracted edge portions by the distance calculating part 4 is performed so as to cover all or some combinations of the edge portions located in an area corresponding to the face of the authentication target 100. In this regard, the distance calculating part 4 may perform the selection for the extracted edge portions so as to cover all or some combinations of the extracted edge portions in all areas containing the area corresponding the face and other areas. In this manner, the distance calculating part 4 obtains the size “Y_{FD1}” of each of the plurality of portions of the first optical image and the size Y_{FD2} of each of the plurality of portions of the second optical image.

After that, the distance calculating part 4 uses the above equation (14) of “MR”=“Y_{FD2}”/“Y_{FD1}” to calculate the image magnification ratio “MR” between the magnification “m₁” of each of the plurality of portions of the first optical image and the magnification “m₂” of each of the corresponding portions of the second optical image based on the size “Y_{FD1}” of each of the plurality of portions of the first optical image and the size “Y_{FD2}” of each of the corresponding portions of the second optical image. After the image magnification ratio “MR” is calculated, the distance calculating part 4 refers to the association information stored in the association information storage part 3 to calculate (identify) the distance “a” to each of the plurality of portions of the face of the authentication target 100 based on the calculated image magnification ratio “MR”.

The three-dimensional information creating part 5 has a function of creating the three-dimensional information of the face of the authentication target 100 based on the distance “a” to each of the plurality of portions of the face of the authentication target 100 calculated by the distance calculating part 4, When the three-dimensional information creating part 5 receives the distance “a” to each of the plurality of portions of the face of the authentication target 100 from the distance calculating part 4, the three-dimensional information creating part 5 creates a three-dimensional grid (a three dimensional mesh) and texture of the face of the authentication target 100 based on the distance “a” to each of the plurality of portions of the face of the authentication target 100 to obtain three-dimensional model of the face of the authentication target 100.

If the distance “a” to each of a plurality of portions of the face of the authentication target 100 calculated by the distance calculating part 4 is insufficient for obtaining the three-dimensional model of the face of the authentication target 100, the three-dimensional information creating part 5 performs interpolation for height (depth) information of the face of the authentication target 100 using an arbitrary interpolation technique such as bilinear interpolation, bicubic interpolation and nearest neighbor interpolation to obtain the three-dimensional model of the face of the authentication target 100.

After that, the three-dimensional information creating part 5 extracts one or more three-dimensional features of the face of the authentication target 100 from the three-dimensional model of the face of the authentication target 100 as the three-dimensional information of the face of the authentication target 100. Examples of the three-dimensional feature of the face extracted from the three-dimensional model of the face contain a height of a nose, a shape of the nose (such as a direction or a shape of a tip of the nose, a shape or a height of a back of the nose and a shape of a nasal wing), a depth of a hollow around an eye and distances between each part (such as eyes, a nose, a mouth, ears and eyebrows) of the face in the depth direction. The three-dimensional feature of the face of the authentication target 100 as described above is used in the three-dimensional face authentication performed by the authenticating part 7 described later.

The authentication information storage part 6 is an arbitrary non-volatile storage medium (for example, a hard disk or a flash memory) for storing the authentication information required for performing the authentication for the authentication target 100. An administrator or the like of the authentication device 1 of the present invention images a person allowed to be authenticated in advance with the authentication device 1 of the present invention or an imaging device having the same function of that of the authentication device 1 to obtain the three-dimensional information, the first image and the second image of the person allowed to be authenticated and register them as the authentication information in the authentication information storage part 6.

When the after-mentioned authenticating part 7 performs the authentication process for the authentication target 100, the three-dimensional information, the first image and/or the second image of the authentication target 100 are compared with the authentication information stored in the authentication information storage part 6 to perform the three-dimensional face authentication, the two-dimensional face authentication and/or the iris authentication.

In this regard, although the authentication information storage part 6 is provided inside the authentication device 1 in the illustrated embodiment, the present invention is not limited thereto. For example, the authentication information storage part 6 may be an external server or an external storage device connected to the authentication device 1 through various wired or wireless networks such as the Internet, a local area network (LAN) and a wide area network (WAN). Further, in the case that the authentication information storage part 6 is the external server or the external storage device, one or more authentication information storage parts 6 may be shared among a plurality of authentication devices 1. In this case, the authentication device 1 uses the communication part 10 to perform communication with the authentication information storage part 6 provided outside the authentication device 1 every time when the authentication is started for the authentication target 100 to perform the authentication for the authentication target 100.

The authenticating part 7 is configured to be capable of performing the three-dimensional face authentication for the authentication target 100 using the three-dimensional information of the face of the authentication target 100 calculated by the three-dimensional information creating part5. More specifically, the authenticating part 7 compares the three-dimensional information of the face of the authentication target 100 created by the three-dimensional information creating part 5 with the three-dimensional information of the face contained in the authentication information registered in the authentication information storage part 6 in advance to perform the three-dimensional face authentication for the authentication target 100.

The authenticating part 7 may determine that the three-dimensional face authentication succeeds if any one of factors (such as the height of the nose and the depth of the hollow around the eye) contained in the three-dimensional information of the face of the authentication target 100 matches the corresponding factor of the three-dimensional information of the face of the authentication information registered in the authentication information storage part 6 in advance. Alternatively, the authenticating part 7 may determine that the three-dimensional face authentication succeeds if all of the factors respectively match the corresponding factors of the three-dimensional information of the face of the authentication information registered in the authentication information storage part 6 in advance.

Further, the authenticating part 7 is configured to be capable of performing the iris authentication and the two-dimensional face authentication for the authentication target 100 using the first image and the second image respectively received from the first imaging system IS1 and the second imaging system IS2 in addition to the three-dimensional face authentication described above. Specifically, the authenticating part 7 is configured to extract a two-dimensional feature amount of the face and iris information of the eye from the first image and/or the second image and perform the iris authentication and the two-dimensional face authentication for the authentication target 100 using the extracted two-dimensional feature amount of the face and the extracted iris information of the eye. A method for extracting the two-dimensional feature amount of the face and the iris information of the eye from the first image and/or the second image with the authenticating part 7 is not particularly limited. Various algorithms known in the art can be used to extract the tow-dimensional feature amount of the face and the iris information of the eye.

The authenticating part 7 is configured to compare the two-dimensional feature amount of the face of the authentication target 100 extracted from the first image and/or the second image respectively received from the first imaging system IS1 and the second imaging system IS2 with the corresponding two-dimensional feature amount of the face extracted from the first image and/or the second image contained in the authentication information registered in the authentication information storage part 6 in advance to perform the two-dimensional face authentication for the authentication target 100. A method of the two-dimensional face authentication performed by the authenticating part 7 is not particularly limited. For example, the authenticating part 7 can perform the two-dimensional face authentication for the authentication target 100 using any two-dimensional face authentication algorithm such as an eigenface algorithm, a linear discriminant analysis method, a graph matching method, a frequency analysis method, a neural network method and a Viola-Jones method.

In addition, the authenticating part 7 is configured to compare the iris information of the eye of the authentication target 100 extracted from the first image and/or the second image respectively received from the first imaging system IS1 and the second imaging system IS2 with the iris information of the eye extracted from the first image and/or the second image contained in the authentication information registered in the authentication information storage part 6 in advance to perform the iris authentication for the authentication target 100. A method of the iris authentication method performed by the authenticating part 7 is not particularly limited. For example, the authenticating part 7 can perform the iris authentication for the authentication target 100 using any iris authentication algorithm such as Dangman algorithm.

In this regard, the first optical system OS1 and the second optical system OS2 of the present embodiment are configured so that the focal length “f₁” of the first optical system OS1 is longer than the focal length “f₂” of the second optical system OS2 (“f₁”>“f₂”) as described above. Therefore, the authentication device 1 of the present embodiment can easily obtain the two images (the first image and the second image) having different angles of view simultaneously. Specifically, an angle of view of the first image obtained by the first imaging system IS1 is narrower than an angle of view of the second image obtained by the second imaging system IS2 and a magnification of the first image obtained by the first imaging system IS1 is higher than a magnification of the second image obtained by the second imaging system IS2 in the present embodiment.

Since an iris which is a fine structure of an eye is used in the iris authentication, it is preferable that the eye of the authentication target 100 is enlarged in an image used for the iris authentication. Compared with the second image, the first image has a narrow angle of view and a high magnification. Therefore, the iris authentication is performed using the first image having the narrow angle of view and the high magnification. Further, since the two-dimensional face authentication requires a wider range of image and does not require information about fine structures compared to the iris authentication, the two-dimensional face authentication is performed using the second image with the wide angle of view and the low magnification.

In the present embodiment, as shown in FIGS. 5(a) and 5(b), the first imaging system IS1 is configured and arranged so that only an area in the vicinity of the eyes of the authentication target 100 containing the eyes of the authentication target 100 is contained in an imaging area of the first imaging system IS1 (an area indicated by the dotted line in FIGS. 5(a) and 5(b)). Further, in the present embodiment, the second imaging system IS2 is configured and arranged so that the entire face of the authentication target 100 is contained in an imaging area of the second imaging system IS2 (an area indicated by the dashed-dotted line in FIGS. 5(a) and 5(b)).

Therefore, the authenticating part 7 of the present embodiment performs the iris authentication for the authentication target 100 using the first image obtained by the first imaging system IS1 and performs the two-dimensional face authentication for the authentication target 100 using the second image obtained by the second imaging system IS2. With this configuration, it is possible to improve accuracies of the iris authentication and the two-dimensional face authentication for the authentication target 100.

As described above, the authenticating part 7 is configured to be capable of performing the three types of authentication, that is the three-dimensional face authentication, the two-dimensional face authentication and the iris authentication. The authenticating part 7 can perform at least one of these three types of authentication according to a security level (for example, “high level”, “medium level” and “low level”) of the authentication device 1 which is set in advance. The security level of the authentication device 1 may be manually set by the administrator or the like of the authentication device 1 using the operation part 8. Alternatively, the authentication device 1 may receive a security level setting command from an external device such as a mobile phone, a smart phone, a notebook computer and a laptop computer of the administrator or the like through the communication part 10 and set the security level according to the received security level setting command.

For example, if the security level of the authentication device 1 is set to the “high level”, the authenticating part 7 performs both of the three-dimensional face authentication and the iris authentication for the authentication target 100. In this case, a processing time required for the authentication becomes longer because both of the three-dimensional face authentication and the iris authentication are performed. On the other hand, it is possible to detect the identity-fraud using the photograph by performing the three-dimensional face authentication. Further, since double checking is performed by the three-dimensional face authentication and the iris authentication, it is possible to improve the accuracy of the authentication for the authentication target 100. In this case, the authenticating part 7 determines that the authentication for the authentication target 100 succeeds only when both of the three-dimensional face authentication and the iris authentication succeed.

In addition, when the iris authentication succeeds and the three-dimensional face authentication fails, there is a high possibility that the identity-fraud using the photograph is performed. Therefore, when the iris authentication succeeds and the three-dimensional face authentication fails, the authenticating part 7 determines that the authentication for the authentication target 100 fails and there is a high possibility that the identity-fraud using the photograph is performed.

Further, if the security level of the authentication device 1 is set to the “medium level”, the authenticating part 7 performs both of the two-dimensional face authentication and the iris authentication for the authentication target 100. Since a processing time required for the two-dimensional face authentication is shorter than a processing time required for the three-dimensional face authentication which needs to process the three-dimensional model of the face, it is possible to shorten the processing time required for the authentication compared with the case where the security level is set to the “high level”. In addition, since the double checking by the two-dimensional face authentication and the iris authentication can be performed, it is possible to improve the accuracy of the authentication for the authentication target 100. In this case, the authenticating part 7 determines that the authentication for the authentication target 100 succeeds only when both of the two-dimensional face authentication and the iris authentication succeed.

If the security level of the authentication device 1 is set to the “low level”, the authenticating part 7 performs the two-dimensional face authentication or the iris authentication for the authentication target 100. In this case, when one of the two-dimensional face authentication and the iris authentication succeeds, the authenticating part 7 determines that the authentication for the authentication target 100 succeeds. Since it is determined that the authentication for the authentication target 100 succeeds when either one of the two-dimensional face authentication and the iris authentication succeeds, it is possible to more shorten the processing time required for the authentication for the authentication target 100. An execution order of the two-dimensional face authentication and the iris authentication is not particularly limited. For example, the authenticating part 7 may be configured to first perform the two-dimensional face authentication and then perform the iris authentication when the two-dimensional face authentication fails because a part of the face of the authentication target 100 is hidden by a mask or the like.

An authentication result (determination result) for the authentication target 100 by the authenticating part 7 is transmitted to the control part 2 through the data bus 11. The control part 2 transmits the received authentication result to an external device (for example, a door unlocking device, a terminal providing an arbitrary application or the like) through the communication part 10. With this configuration, the external device can perform an arbitrary process according to the received authentication result. For example, if the external device receives a result indicating that the authentication for the authentication target 100 succeeds, the external device may release a physical lock such as a door lock or unlock software or allow any application to be launched. On the other hand, if the external device receives a result indicating that the authentication for the authentication target 100 fails, the external device may maintain the physical lock such as the door lock or the lock of the software or may not allow any application to be launched. Further, for example, if the external device receives a result indicating that the identify-fraud using the photograph is performed, the external device notifies a security warning message to the administrator of the authentication device 1 or an administrator of the external device.

As described above, since the authenticating part 7 selects the authentication processes to be performed according to the security level set in advance, the authentication device 1 of the present invention can be used for various security applications.

Referring back to FIG. 4, the operation part 8 is used by the user, the administrator or the like of the authentication device 1 to perform operations. The operation part 8 is not particularly limited as long as the user of the authentication device 1 can perform the operations. For example, a mouse, a keyboard, a ten-key pad, a button, a dial, a lever, a touch panel or the like can be used as the operation part 8. The operation part 8 transmits a signal corresponding to the operation by the user of the authentication device 1 to the processor of the control part 2. For example, as described above, the administrator or the like of the authentication device 1 can set the security level of the authentication device 1 by using the operation part 8.

The communication part 10 has functions of inputting data into the authentication device 1 and outputting data from the authentication device 1 to an external device through the wired communication or wireless communication. The communication part 10 may be configured to be connectable to a network such as the Internet. In this case, the authentication device 1 can use the communication part 10 to communicate with an external device such as an externally provided web server or data server.

As described above, in the authentication device 1 of the present embodiment, the first optical system OS1 and the second optical system OS2 are configured so that the focal length “f₁” of the first optical system OS1 and the focal length “f₂” of the second optical system OS2 are different from each other (“f₁”≠“f₂”), and thereby the change of the magnification “m₁” of the first optical image with respect to the distance “a” to each of the plurality of portions of the face of the authentication target 100 and the change of the magnification “m₂” of the second optical image with respect to the distance “a” to each of the plurality of portions of the face of the authentication target 100 are different from each other. Therefore, the authentication device 1 of the present embodiment can uniquely calculate the distance “a” to each of the plurality of portions of the face of the authentication target 100 based on the image magnification ratio “MR” (“m₂”/“m₁”) between the magnification “m₁” of the first optical image and the magnification “m₂” of the second optical image. Further, the authentication device 1 of the present embodiment can create the three-dimensional information of the face of the authentication target 100 based on the calculated distance “a” to each of the plurality of portions of the face of the authentication target 100 to perform the three-dimensional face authentication for the authentication target 100.

### Second Embodiment

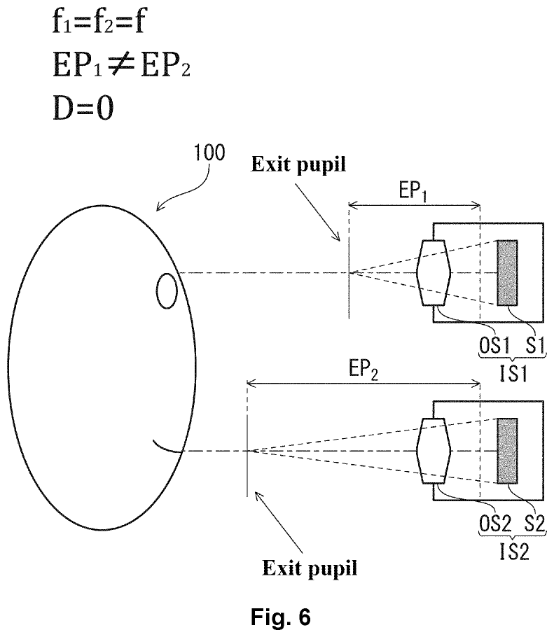

Next, an authentication device according to a second embodiment of the present invention will be described in detail with reference to FIG. 6. FIG. 6 is a block diagram schematically showing a first imaging system and a second imaging system of the authentication device according to the second embodiment of the present invention.

Hereinafter, the authentication device 1 of the second embodiment will be described by placing emphasis on the points differing from the authentication device 1 of the first embodiment with the same matters being omitted from the description. The authentication device 1 of the present embodiment has the same configuration as that of the authentication device 1 of the first embodiment except that the configurations of the first optical system OS1 and the second optical system OS2 are modified.

The authentication device 1 of the present embodiment is characterized in that the first optical system OS1 and the second optical system OS2 are configured so as to satisfy the second condition that the distance “EP₁” from the exit pupil of the first optical system OS1 to the image formation position of the first optical image when the measurement target is located at the infinite distance point and the distance “EP₂” from the exit pupil of the second optical system OS2 to the image formation position of the second optical image when the measurement target is located at the infinite distance point are different from each other (“EP₁”≠“EP₂”) among the above-described three conditions required for calculating the distance “a” to the measurement target (that is, each of the plurality of portions of the face of the authentication target 100) based on the image magnification ratio “MR”. On the other hand, in the present embodiment, the first optical system OS1 and the second optical system OS2 are configured and arranged so as not to satisfy the other two conditions (“f₁”≠“f₂” and “D”≠0) among the above-described three conditions. Further, the authentication device 1 of the present embodiment is configured to satisfy the fourth condition that the image magnification ratio “MR” is established as the function of the distance “a”.

Therefore, the general equation (13) for calculating the distance “a” to the measurement target (that is, each of the plurality of portions of the face of the authentication target 100) based on the image magnification ratio “MR” is simplified by the conditions of “f₁”=“f₂”=“f” and “D”=0 and can be expressed by the following equation (17).

$$\begin{matrix}[ Equation 17 ] & \\ a = \frac{K \cdot ( {f}^{2} - {EP}_{1} \cdot f ) - MR \cdot ( {f}^{2} - {EP}_{2} \cdot f )}{MR \cdot {EP}_{2} - K \cdot {EP}_{1}} & ( 17 )\end{matrix}$$

Here, the coefficient “K” is expressed by the following equation (18).

$$\begin{matrix}[ Equation 18 ] & \\ K = \frac{{a}_{FD 1} - f}{{a}_{FD 2} - f} \cdot \frac{{f}^{2} - {EP}_{2} \cdot f + {EP}_{2} \text{?} {a}_{FD 2}}{{f}^{2} - {EP}_{1} \cdot f + {EP}_{1} \text{?} {a}_{FD 1}} \\ \text{?} \text{indicates text missing or illegible when filed} & ( 18 )\end{matrix}$$

As described above, in the authentication device 1 of the present embodiment, the first optical system OS1 and the second optical system OS2 are configured so that the distance “EP₁” from the exit pupil of the first optical system OS1 to the image formation position of the first optical image when the measurement target (that is, each of the plurality of portions of the face of the authentication target 100) is located at the infinite distance point and the distance “EP₂ from the exit pupil of the second optical system OS2 to the image formation position of the second optical image when the measurement target is located at the infinite distance point are different from each other (“EP₁” “EP₂”), and thereby the change of the magnification “m₁” of the first optical image with respect to the distance “a” to each of the plurality of portions of the face of the authentication target 100 and the change of the magnification “m₂” of the second optical image with respect to the distance “a” to each of the plurality of portions of the face of the authentication target 100 are different from each other. Therefore, the authentication device 1 of the present embodiment can uniquely calculate the distance “a” to each of the plurality of portions of the face of the authentication target 100 based on the image magnification ratio “MR” (“m₂”/“m₁”) between the magnification “m₁” of the first optical image and the magnification “m₂” of the second optical image. Further, the authentication device 1 of the present embodiment can create the three-dimensional information of the face of the authentication target 100 based on the calculated distance “a” to each of the plurality of portions of the face of the authentication target 100 to perform the three-dimensional face authentication for the authentication target 100.

According to the present embodiment, it is also possible to provide the same effect as that of the above-described first embodiment. In this regard, the configurations and the arrangements of the first optical system OS1 and the second optical system OS2 in the present embodiment may be any aspect as long as the above-mentioned second condition (“EP₁”≠“EP₂”) is satisfied, and thereby the change of the magnification “m₁” of the first optical image with respect to the distance “a” to each of the plurality of portions of the face of the authentication target 100 and the change of the magnification “m₂” of the second optical image with respect to the distance “a” to each of the plurality of portions of the face of the authentication target 100 are different from each other.

Further, in the present embodiment, since the focal length “f₁” of the first optical system OS1 is equal to the focal length “f₂” of the second optical system OS2 (“f₁”=“f₂”=“f”), the iris authentication for the authentication target 100 may be performed using either one of the first image obtained by the first imaging system IS1 and the second image obtained by the second imaging system IS2.

### Third Embodiment

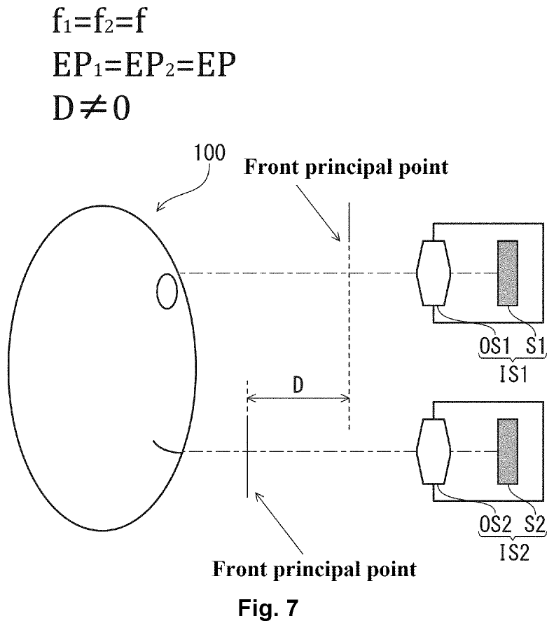

Next, an authentication device according to a third embodiment of the present invention will be described in detail with reference to FIG. 7. FIG. 7 is a block diagram schematically showing a first imaging system and a second imaging system of the authentication device according to the third embodiment of the present invention.

Hereinafter, the authentication device 1 of the third embodiment will be described by placing emphasis on the points differing from the authentication device 1 of the first embodiment with the same matters being omitted from the description. The authentication device 1 of the present embodiment has the same configuration as that of the authentication device 1 of the first embodiment except that the configurations and the arrangements of the first optical system OS1 and the second optical system OS2 are modified.

The authentication device 1 of the present embodiment is characterized in that the first optical system OS1 and the second optical system OS2 are configured and arranged so as to satisfy the third condition that the difference “D” in the depth direction (the optical axis direction) exists between the front principal point of the first optical system OS1 and the front principal point of the second optical system OS2 among the above-described three conditions required to calculate the distance “a” to the measurement target (that is, each of the plurality of portions of the face of the authentication target 100) based on the image magnification ratio “MR”. On the other hand, in the present embodiment, the first optical system OS1 and the second optical system OS2 are configured so as not to satisfy the other two conditions (“f₁”≠“f₂” and “EP₁”≠“EP₂”) among the above-described three conditions. Further, the authentication device 1 of the present embodiment is configured to satisfy the fourth condition that the image magnification ratio “MR” is established as the function of the distance “a”.

Therefore, the general equation (13) for calculating the distance a to the measurement target (that is, each of the plurality of portions of the face of the authentication target 100) based on the image multiplication ratio “MR” is simplified by the conditions of “f₁”=“f₂”=“f” and “EP₁”=“EP₂”=“EP” and can be expressed by the following equation (19).

$$\begin{matrix}[ Equation 19 ] & \\ a = \frac{K \cdot ( {f}^{2} - EP \cdot f ) - MR \cdot ( {f}^{2} - EP \cdot f + EP \cdot D )}{EP \cdot ( MR - K )} & ( 19 )\end{matrix}$$

Here, the coefficient K is expressed by the following equation (20).

$$\begin{matrix}[ Equation 20 ] & \\ K = \frac{{a}_{FD 1} - f}{{a}_{FD 2} - f} \cdot \frac{{f}^{2} - EP \cdot f + EP \cdot {a}_{FD 2}}{{f}^{2} - EP \cdot f + EP \cdot {a}_{FD 1}} & ( 20 )\end{matrix}$$

As described above, in the authentication device 1 of the present embodiment, the first optical system OS1 and the second optical system OS2 are configured and arranged so that the difference “D” in the depth direction (the optical axis direction) exists between the front principal point of the first optical system OS1 and the front principal point of the second optical system OS2 (“D”≠0), and thereby the change of the magnification “m₁” of the first optical image with respect to the distance “a” to each of the plurality of portions of the face of the authentication target 100 and the change of the magnification “m₂” of the second optical image with respect to the distance “a” to each of the plurality of portions of the face of the authentication target 100 are different from each other. Therefore, the authentication device 1 of the present embodiment can uniquely calculate the distance “a” to each of the plurality of portions of the face of the authentication target 100 based on the image magnification ratio “MR” (“m₂”/“m₁”) between the magnification “m₁” of the first optical image and the magnification “m₂” of the second optical image. Further, the authentication device 1 of the present embodiment can create the three-dimensional information of the face of the authentication target 100 based on the calculated distance “a” to each of the plurality of portions of the face of the authentication target 100 to perform the three-dimensional face authentication for the authentication target 100.

According to the present embodiment, it is also possible to provide the same effect as that of the above-described first embodiment. In this regard, the configurations and the arrangements of the first optical system OS1 and the second optical system OS2 in the present embodiment may be any aspect as long as the above-mentioned third condition (“D”≠0) is satisfied, and thereby the change of the magnification “m₁” of the first optical image with respect to the distance “a” to each of the plurality of portions of the face of the authentication target 100 and the change of the magnification “m₂” of the second optical image with respect to the distance “a” to each of the plurality of portions of the face of the authentication target 100 are different from each other.

Further, in the present embodiment, since the focal length “f₁” of the first optical system OS1 is equal to the focal length “f₂” of the second optical system OS2 (“f₁”=“f₂”=“f”), the iris authentication for the authentication target 100 may be performed using either one of the first image obtained by the first imaging system IS1 and the second image obtained by the second imaging system IS2.

### Fourth Embodiment

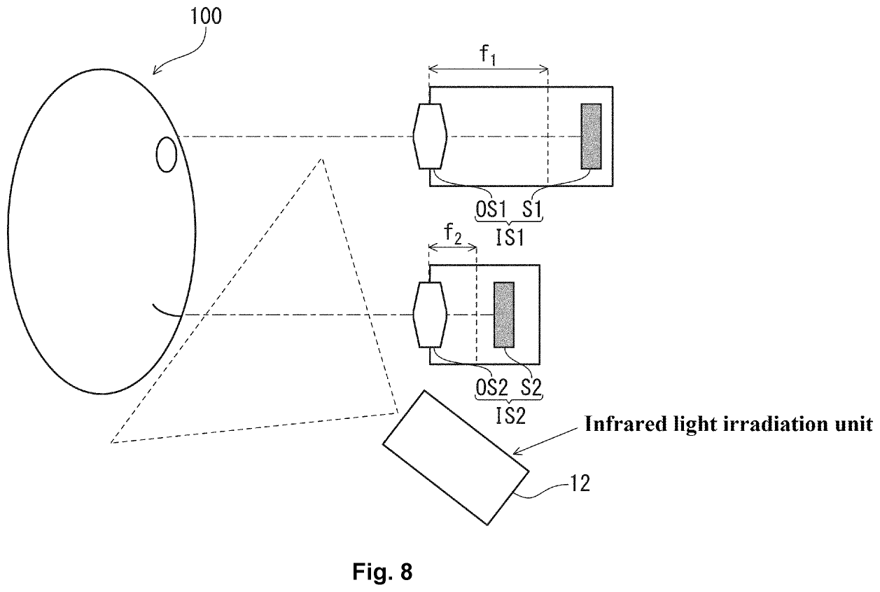

Next, an authentication device according to a fourth embodiment of the present invention will be described in detail with reference to FIG. 8. FIG. 8 is a block diagram schematically showing a first imaging system, a second imaging system and an infrared light irradiation unit of the authentication device according to the fourth embodiment of the present invention.

Hereinafter, the authentication device of the fourth embodiment will be described by placing emphasis on the points differing from the authentication device 1 of the first embodiment with the same matters being omitted from the description. The authentication device 1 of the present embodiment has the same configuration as that of the authentication device of the first embodiment except that the authentication device 1 further includes an infrared light irradiation unit 12 for irradiating infrared light onto the authentication target 100 and at least one of the first image sensor S1 and the second image sensor S2 is configured to be capable of imaging the infrared light.

The infrared light irradiation unit 12 is connected to the data bus 11 of the authentication device 1. The infrared light irradiation unit 12 has a function of irradiating the infrared light onto the authentication target 100 according to the control from the processor of the control part 2 of the authentication device 1. The infrared light irradiation unit 12 is not particularly limited as long as it can irradiate the infrared light onto the authentication target 100 according to the control from the processor of the control part 2 of the authentication device 1. For example, an infrared light LED can be used as the infrared light irradiation unit 12.

In the present embodiment, at least one the first image sensor S1 of the first imaging system IS1 and the second image sensor S2 of the second imaging system IS2 is configured to be capable of imaging the infrared light. In the present embodiment, when the authentication target 100 is imaged by the first imaging system IS1 and the second imaging system IS2, the infrared light irradiation unit 12 irradiates the infrared light onto the authentication target 100 according to the control from the processor of the control part 2. Since at least one of the first image sensor S1 of the first imaging system IS1 and the second image sensor S2 of the second imaging system IS2 is configured to be capable of imaging the infrared light, at least one of the first imaging system IS1 and the second imaging system IS2 can obtain an infrared image of the authentication target 100 even if the authentication target 100 is in a dark place.

If visible light is directly irradiated onto the eyes of the authentication target 100 at the time of obtaining the image of the eyes for the iris authentication, a burden on the authentication target 100 at the time of the authentication is large because the visible light is glaring. In addition, a reflectivity of the eyes is high in the infrared range. Therefore, in order to reduce the burden on the authentication target 100 and improve the accuracy of the iris authentication, it is preferable to irradiate the infrared light onto the eyes of the authentication target 100 at the time of obtaining the image of the eyes to obtain the infrared image of the eyes and perform the iris authentication using the obtained infrared image. Therefore, in the present embodiment, at least one of the first image sensor S1 of the first imaging system IS1 and the second image sensor S2 of the second imaging system IS2 which is used for obtaining the image used for the iris authentication for the authentication target 100 (in the first embodiment and the present embodiment, the first image sensor S1 of the first imaging system IS1) is configured to be capable of imaging the infrared light. With this configuration, it is possible to improve the accuracy of the iris authentication for the authentication target 100 and reduce the burden on the authentication target 100 at the time of the authentication.

In addition, an aspect in which both of the first image sensor S1 and the second image sensor S2 are configured to be capable of imaging infrared light is also involved within the scope of the present invention. In this case, in addition to the merit of performing the iris authentication using the infrared image described above, the infrared images of the face of the authentication target 100 can be obtained even if the authentication target 100 is in a dark place. Thus, the three-dimensional face authentication and the two-dimensional face authentication for the authentication target 100 described above can be performed.

### Fifth Embodiment

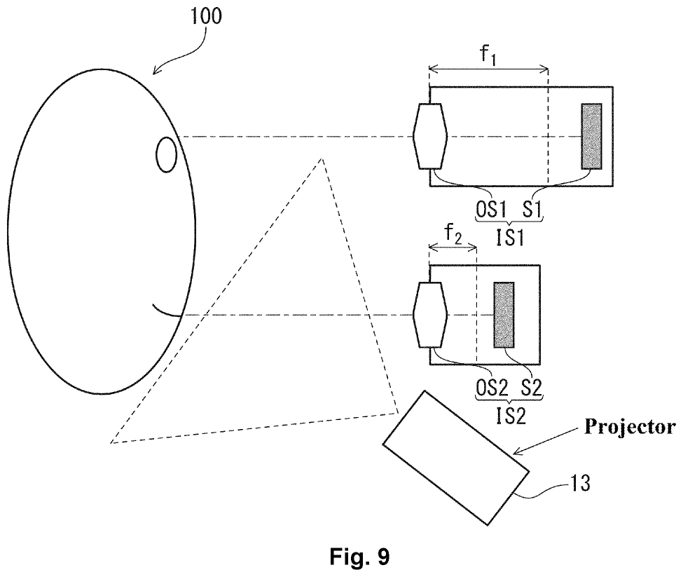

Next, an authentication according to a fifth embodiment of the present invention will be described in detail with reference to FIG. 9. FIG. 9 is a block diagram schematically showing a first imaging system, a second imaging system and a projector of the authentication device according to the fifth embodiment of the present invention.

Hereinafter, the authentication device of the fifth embodiment will be described by placing emphasis on the points differing from the authentication device 1 of the first embodiment with the same matters being omitted from the description. The authentication device 1 of the present embodiment has the same configuration as that of the authentication device of the first embodiment except that the authentication device 1 further includes a projector 13 for irradiating a predetermined pattern onto the authentication target 100.

The projector 13 is connected to the data bus 11 of the authentication device 1. The projector 13 has a function of projecting the predetermined pattern (for example, a vertical stripe pattern, a horizontal stripe pattern, a grid pattern or a dot pattern) onto the authentication target 100 according to the control from the processor of the control part 2 of the authentication device 1. The projector 13 is not particularly limited as long as it can project the predetermined pattern onto the authentication target 100 according to the control from the processor of the control part 2 of the authentication device 1. For example, a CRT projector, a liquid crystal projector or the like can be used as the projector 13.

In the present embodiment, when the authentication target 100 is imaged by the first imaging system IS1 and the second imaging system IS2, the projector 13 projects the predetermined pattern onto the authentication target 100 according to the control from the processor of the control part 2. Therefore, the first imaging system IS1 and the second imaging system IS2 image the authentication target 100 onto which the predetermined pattern is projected.

Since the predetermined pattern irradiated onto the authentication target 100 can be used as the edge portions used by the distance calculating part 4 to calculate the distance “a” to each of the plurality of portions of the face of the authentication target 100, it is possible to increase the number of distance measured portions of the authentication target 100. Therefore, even when a clear edge portion does not exist at an arbitrary portion of the authentication target 100, it is possible to calculate the distance “a” to this portion. In addition, since the number of the distance measured portions of the authentication target 100 is increased, the accuracy of the three-dimensional modeling for the face of the authentication target 100 is improved and thus it is possible to improve the accuracy of the three-dimensional face authentication for the authentication target 100.

As described in detail with reference to the embodiments, the authentication device 1 of the present invention can uniquely calculate the distance “a” to each of the plurality of portions of the face of the authentication target 100 based on the magnification ratio “MR” (“m₂”/“m₁”) between the magnification “m₁” of the first optical image and the magnification “m₂” of the second optical image without using any parallel disparity between images. Further, the authentication device 1 of the present invention can create the three-dimensional information of the face of the authentication target 100 based on the calculated distance “a” to each of the plurality of portions of the face of the authentication target 100 to perform the three-dimensional face authentication for the authentication target 100.

Therefore, since the authentication device 1 of the present invention does not need to secure a large parallel disparity unlike the conventional stereo camera type authentication device using the parallel disparity between the images, it is possible to accurately calculate the distance “a” to each of the plurality of portions of the face of the authentication target 100 even if the first optical system OS1 and the second optical system OS2 are arranged with being close to each other. Thus, it is possible to realize the downsizing of the authentication device 1 as compared with the conventional stereo camera type authentication device. Further, since the authentication device 1 of the present invention does not use any parallel disparity for calculating the distance “a” to each of the plurality of portions of the face of the authentication target 100, it is possible to accurately calculate the distance “a” to each of the plurality of portions of the face of the authentication target 100 even if the authentication target 100 is located at a position very close to the authentication device 1. In addition, according to the present invention, since it becomes unnecessary to design the authentication device 1 with considering the parallel disparity, it is possible to increase a degree of freedom of design of the authentication device 1.

Further, although the two optical systems (the first optical system OS1 and the second optical system OS2) are used in the above embodiments, the number of the optical systems used in the present invention is not limited thereto. For example, an aspect comprising an additional optical system in addition to the first optical system OS1 and the second optical system OS2 is also involved within the scope of the present invention. In this instance, the additional optical system is configured and arranged so that a change of a magnification of an optical image formed by the additional optical system with respect to the distance “a” to each of the plurality of portions of the face of the authentication target 100 is different from the change of the magnification “m₁” of the first optical image with respect to the distance “a” to each of the plurality of portions of the face of the authentication target 100 and the change of the magnification “m₂” of the second optical image with respect to the distance “a” to each of the plurality of portions of the face of the authentication target 100.

Further, although the first optical system OS1 and the second optical system OS2 are configured and arranged so as to satisfy one of the above-described three conditions required for calculating the distances “a” to the measurement target (that is, each of the plurality of portions of the face of the authentication target 100) based on the image magnification ratio “MR” in the embodiments described above, the present invention is not limited thereto as long as the first optical system OS1 and the second optical system OS2 are configured and arranged so as to satisfy at least one of the above-described three conditions. For example, an aspect in which the first optical system OS1 and the second optical system OS2 are configured and arranged so as to satisfy all or any combinations of the above-described three conditions is also involved within the scope of the present invention.

### Authentication Method

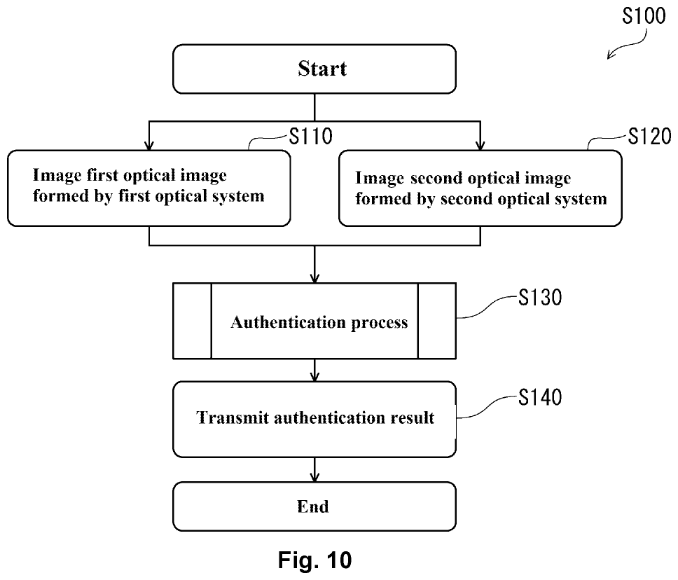

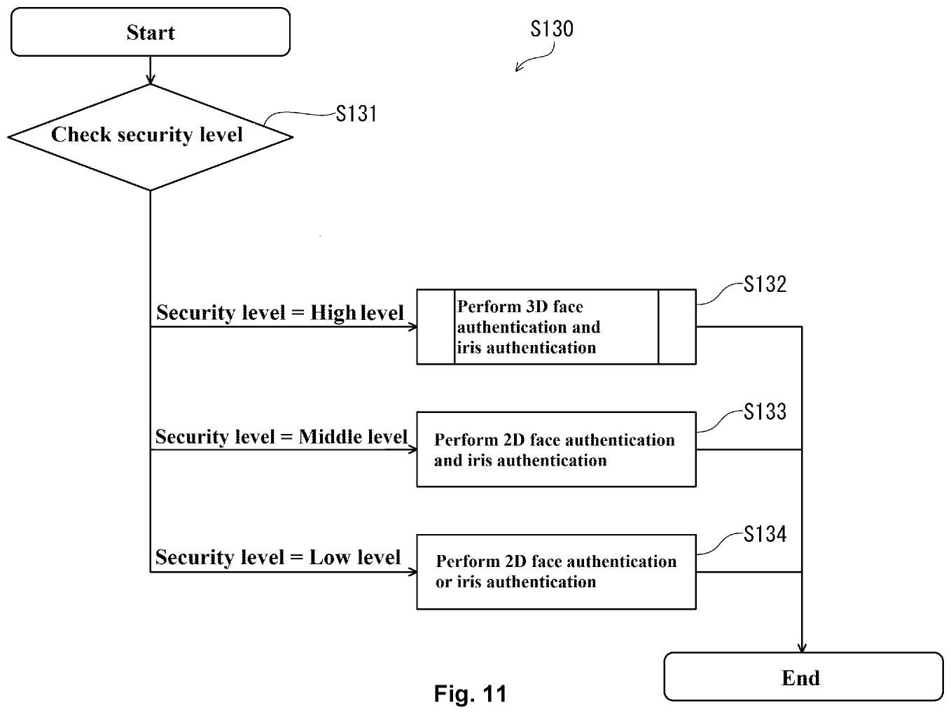

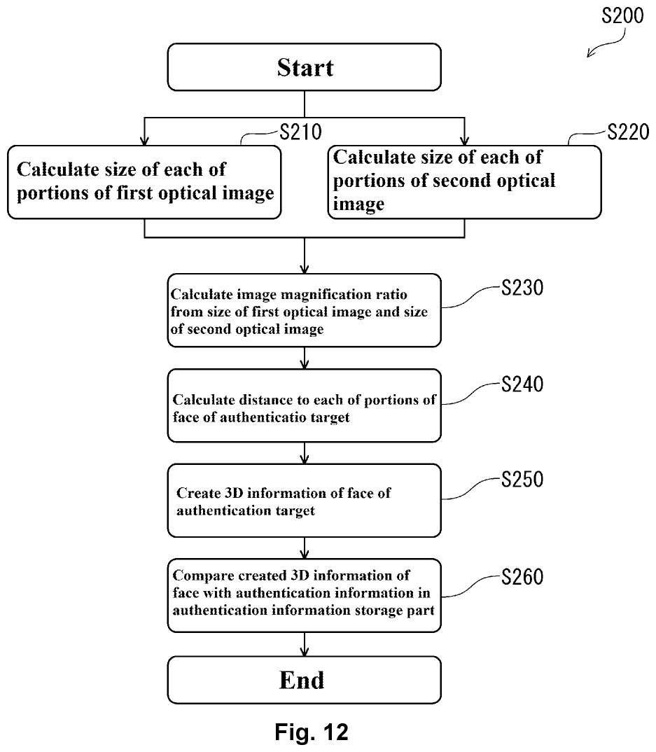

Next, an authentication method performed by the authentication device 1 of the present invention will be described with reference to FIGS. 10, 11 and 12. FIG. 10 is a flowchart showing the authentication method performed by the authentication device of the present invention. FIG. 11 is a flowchart showing an authentication process in the authentication method performed by the authentication device of the present invention in more detail. FIG. 12 is a flowchart showing the three-dimensional face authentication in the authentication method performed by the authentication device of the present invention.

Although the authentication method described below can be performed by using the authentication devices 1 according to the first to fifth embodiments of the present invention and an arbitrary device having a function equivalent to that of the authentication device 1, the authentication method will be described as assuming that the authentication method is performed by the authentication device 1 according to the first embodiment for the sake of explanation.

An authentication method S100 shown in FIG. 10 starts when the authentication target 100 uses the operation part 8 to execute an operation for starting the authentication for the authentication target 100. At a step S110, the first optical image formed by the first optical system OS1 is imaged by the first image sensor S1 of the first imaging system IS1 to obtain the first image. The obtained first image is transmitted to the control part 2, the distance calculating part 4 and the authenticating part 7 through the data bus 11.

On the other hand, at a step S120, the second optical image formed by the second optical system OS2 is imaged by the second image sensor S2 of the second imaging system IS2 to obtain the second image. The obtained second image is transmitted to the control part 2, the distance calculating part 4 and the authenticating part 7 through the data bus 11. In this regard, the step S110 and the step S120 may be performed simultaneously or individually.

After the step S110 and the step S120 have been completed, the authentication process for the authentication target 100 is performed at a step S130. FIG. 11 shows the authentication process for the authentication target 100 performed at the step S130 in more detail.

At a step S131, the authenticating part 7 checks the security level of the authentication device 1 set in advance. When it is determined at the step S131 that the security level of the authentication device 1 is set to the “high level”, the authentication process proceeds to a step S132. At the step S132, the three-dimensional face authentication and the iris authentication for the authentication target 100 are performed. The iris authentication for the authentication target 100 at the step S132 is performed by the authenticating part 7 using the first image or the second image (in the first embodiment, the first image having the narrow angle and the high magnification is used). At the same time, the three-dimensional face authentication for the authentication target 100 is performed at the step S132.

FIG. 12 shows the three-dimensional face authentication S200 for the authentication target 100 performed at the step S132. The three-dimensional face authentication S200 for the authentication target 100 will be described in detail with reference to FIG. 12. First, at a step S210, the distance calculating part 4 calculates the size (image height or image width) “Y_{FD1}” of each of the plurality of portions of the first optical image from the first image. Similarly, at a step S220, the distance calculating part 4 calculates the size (image height or image width) “Y_{FD2}” of each of the plurality of portions of the second optical image from the second image. In this regard, the step S210 and the step S220 may be performed simultaneously or individually.

When both the size “Y_{FD1}” of each of the plurality of portions of the first optical image and the size “Y_{FD2}” of each of the plurality of portions of the second optical image are calculated at the step S210 and the step S220, the process proceeds to a step S230. At the step S230, the distance calculating part 4 calculates the image magnification ratio “MR” between the magnification “m₁” of each of the plurality of portions of the first optical image and the magnification “m₂” of each of the corresponding portions of the second optical image based on the above equation (14) “MR”=“Y_{FD2}”/“Y_{FD1}” calculated from the size “Y_{FD1}” of each of the plurality of portions of the first optical image and the size “Y_{FD2}” of the corresponding portion of the second optical image.

Next, at a step S240, the distance calculating part 4 refers to the association information stored in the association information storage part 3 to calculate (identify) the distance “a” to each of the plurality of portions of the face of the authentication target 100 based on the calculated image magnification ratio “MR”. When the distance “a” to each of the portions of the face of the authentication target 100 is calculated at the step S240, the process proceeds to a step S250.

At the step S250, the three-dimensional information creating part 5 receives the distance “a” to each of the plurality of portions of the face of the authentication target 100 calculated by the distance calculating part 4, After that, the three-dimensional information creating part 5 creates the three-dimensional information of the face of the authentication target 100 based on the distance “a” to each of the plurality of portions of the face of the authentication target 100.

Next, at a step S260, the authenticating part 7 performs the three-dimensional face authentication for the authentication target 100 by comparing the three-dimensional information of the face of the authentication target 100 calculated by the three-dimensional information creating part 5 with the three-dimensional information of the face contained in the authentication information registered in the authentication information storage part 6 in advance.

If any one of the plurality of factors such as the height of the nose and the depth of the hollow around the eye contained in the three-dimensional information of the face of the authentication target 100 matches the corresponding factor of the three-dimensional information of the face of the authentication information registered in the authentication information storage part 6 in advance, the authenticating part 7 determines that the three-dimensional face authentication succeeds. Alternatively, if all of the plurality of factors match all of the corresponding factors of the three-dimensional information of the face of the authentication information registered in the authentication information storage part 6 in advance, the authenticating part 7 determines that the three-dimensional face authentication succeeds. As described above, the three-dimensional face authentication S200 for the authentication target 100 is performed at the step S132.

Referring back to FIG. 11, in the authentication at the step S132, the authenticating part 7 determines that the authentication for the authentication target 100 succeeds only when both of the iris authentication and the three-dimensional face authentication S200 succeed. Further, when the iris authentication succeeds and the three-dimensional face authentication fails, the authenticating part 7 determines that the identity-fraud using the photograph is performed in addition to the failure of the authentication for the authentication target 100. The authenticating part 7 transmits the determination on the authentication for the authentication target 100 as described above to the control part 2 and the authentication process at the step S130 ends.

On the other hand, when it is determined at the step S131 that the security level of the authentication device 1 is set to the “medium level”, the authentication process proceeds to a step S133. At the step S133, the authenticating part 7 performs both of the two-dimensional face authentication and the iris authentication for the authentication target 100 using the first image and/or the second image. In the authentication at the step S133, the authenticating part 7 determines that the authentication for the authentication target 100 succeeds only when both of the iris authentication and the two-dimensional face authentication succeed. After that, the authenticating part 7 transmits the determination on the authentication for the authentication target 100 to the control part 2 and then the authentication process of the step S130 ends.

Further, when it is determined at the step S131 that the security level of the authentication device 1 is set to the “low level”, the authentication process proceeds to a step S134. At the step S134, the authenticating part 7 performs the two-dimensional face authentication or the iris authentication for the authentication target 100 using the first image and/or the second image. In the authentication at the step S134, when at least one of the iris authentication and the two-dimensional face authentication succeeds, the authenticating part 7 determines that the authentication for the authentication target 100 succeeds. After that, the authenticating part 7 transmits the determination on the authentication for the authentication target 100 to the control part 2 and then the authentication process at the step S130 ends.

Referring back to FIG. 10, at a step S140, the control part 2 receives the determination (authentication result) on the authentication for the authentication target 100 from the authenticating part 7. The control part 2 transmits the received authentication result to an arbitrary external device through the communication part 10 and then the authentication method S100 ends. This allows the arbitrary external device to perform a process according to the authentication result.

Although the authentication device of the present invention has been described above based on the illustrated embodiments, the present invention is not limited thereto. Each configuration of the present invention can be replaced with any configuration capable of performing the same function or any configuration can be added to each configuration of the present invention.

A person having ordinary skills in the art and the technique pertaining to the present invention may modify the configuration of the authentication device of the present invention described above without meaningfully departing from the principle, the spirit and the scope of the present invention and the authentication device having the modified configuration is also involved in the scope of the present invention. For example, an aspect in which the authentication devices according to the first to fifth embodiments are arbitrarily combined is also involved within the scope of the present invention.

Further, the number and the type of the components of the authentication device shown in FIGS. 4 to 9 are merely illustrative examples and the present invention is not necessarily limited thereto. An aspect in which any component is added or combined or any component is omitted without departing from the principle and intent of the present invention is also involved within the scope of the present invention. Furthermore, each component of the authentication device may be realized by hardware, software or a combination thereof.

In addition, the numbers and the types of the steps of the authentication method S100 shown in FIGS. 10 to 12 are merely illustrative examples and the present invention is not necessarily limited to these. An aspect that any step is added or combined for any purpose or any step is omitted without departing from the principle and intent of the present invention is also involved within the scope of the present invention.

### INDUSTRIAL APPLICABILITY

The authentication of the present invention uses the at least two optical systems whose changes of the magnifications of the optical images according to the distance to each of the plurality of portions of the face of the authentication target are different from each other to measure the distance to each of the plurality of portions of the face of the authentication target based on the image magnification ratio (the ratio between the magnifications) of the two optical images respectively formed by the two optical systems. Further, the authentication device of the present invention can create the three-dimensional information of the face of the authentication target based on the calculated distance to each of the plurality of portions of the face of the authentication target to perform the three-dimensional face authentication for the authentication target.

Therefore, the authentication device of the present invention does not need to secure a large parallel disparity unlike the conventional stereo camera type authentication device using the parallel disparity between the images. Thus, it is possible to accurately calculate the distance to each of the plurality of portions of the face of the authentication target even if the two optical systems are arranged with being close to each other. With this configuration, as compared with the conventional stereo camera type authentication device, it is possible to more downsize the authentication device. Further, since the authentication device of the present invention does not use the parallel disparity for calculating the distance to each of the plurality of portions of the face of the authentication target, it is possible to accurately calculate the distance to each of the plurality of portions of the face of the authentication target even if the authentication target is located at a position very close to the authentication device. In addition, according to the present invention, since it becomes unnecessary to design the authentication device with considering the parallel disparity, it is possible to increase a degree of freedom of design of the authentication device. Thus, the present invention has industrial applicability.

1. An authentication device, comprising
a first imaging system having a first optical system for collecting light from an authentication target to form a first optical image of the authentication target and a first image sensor for imaging the first optical image formed by the first optical system;
a second imaging system having a second optical system for collecting the light from the authentication target to form a second optical image of the authentication target and a second image sensor for imaging the second optical image formed by the second optical system;
a distance calculating part for calculating a distance to each of a plurality of portions of a face of the authentication target based on the first optical image and the second optical image;
a three-dimensional information creating part for creating three-dimensional information of the face of the authentication target based on the distance to each of the plurality of portions of the face of the authentication target calculated by the distance calculating part; and
an authenticating part configured to be capable of performing three-dimensional face authentication for the authentication target using the three-dimensional information of the face of the authentication target created by the three-dimensional information creating part,
wherein the first optical system and the second optical system are configured so that a change of a magnification of the first optical image according to the distance to each of the plurality of portions of the face of the authentication target is different from a change of a magnification of the second optical image according to the distance to each of the plurality of portions of the face of the authentication target, and
wherein the distance calculating part calculates the distance to each of the plurality of portions of the face of the authentication target based on an image magnification ratio between the magnification of the first optical image and the magnification of the second optical image.

2. The authentication device as claimed in claim 1, wherein the first optical system and the second optical system are configured so that a distance from an exit pupil of the first optical system to an image formation position of the first optical image formed by the first optical system when the authentication target is located at an infinite distance point is different from a distance from an exit pupil of the second optical system to an image formation position of the second optical image formed by the second optical system when the authentication target is located at the infinite distance point, and thereby the change of the magnification of the first optical image according to the distance to each of the plurality of portions of the face of the authentication target is different from the change of the magnification of the second optical image according to the distance to each of the plurality of portions of the face of the authentication target.

3. The authentication device as claimed in claim 1, wherein a difference in a depth direction exists between a front principal point of the first optical system and a front principal point of the second optical system, and thereby the change of the magnification of the first optical image according to the distance to each of the plurality of portions of the face of the authentication target is different from the change of the magnification of the second optical image according to the distance to each of the plurality of portions of the face of the authentication target.

4. The authentication device as claimed in claim 1, wherein the first optical system and the second optical system are configured so that a focal length of the first optical system and a focal length of the second optical system are different from each other, and thereby the change of the magnification of the first optical image according to the distance to each of the plurality of portions of the face of the authentication target is different from the change of the magnification of the second optical image according to the distance to each of the plurality of portions of the face of the authentication target.

5. The authentication device as claimed in claim 1, wherein the authenticating part is configured to be capable of performing iris authentication and two-dimensional face authentication for the authentication target using a first image obtained by imaging the first optical image with the first image sensor and a second image obtained by imaging the second optical image with the second image sensor in addition to the three-dimensional face authentication.

6. The authentication device as claimed in claim 5, wherein the authenticating part is configured to perform at least one of the three-dimensional face authentication, the two-dimensional face authentication and the iris authentication according to a security level set in advance.

7. The authentication device as claimed in claim 5, wherein the first optical system and the second optical system are configured so that a focal length of the first optical system is longer than a focal length of the second optical system, and
wherein the authenticating part performs the iris authentication for the authentication target using the first image obtained by the first image sensor and performs the two-dimensional face authentication for the authentication target using the second image obtained by the second image sensor.

8. The authentication device as claimed in claim 1, further comprising a projector for projecting a predetermined pattern onto the authentication target, and
wherein the distance calculating part calculates the distance to each of the plurality of portions of the face of the authentication target based on the first optical image and the second optical image of the authentication target on which the predetermined pattern is projected by the projector.

9. The authentication device as claimed in claim 1, further comprising an infrared light irradiation unit for irradiating infrared light onto the authentication target, and
wherein at least one of the first image sensor of the first imaging system and the second image sensor of the second imaging system is configured to be capable of imaging the infrared light.
